(19) United States
(12) Patent Application Publication
(10) Pub. No.: US 2016/0262567 A1
(43) Pub. Date: Sep. 15, 2016

(54) BEVERAGE PREPARATION APPARATUS

(71) Applicant: SHARP KABUSHIKI KAISHA, Osaka-shi, Osaka (JP)

(72) Inventors: Nahoko SAKUMASU, Osaka-shi, Osaka (JP); Kazuya KITATANI, Osaka-shi, Osaka (JP); Yasuaki SAKANE, Osaka-shi, Osaka (JP)

(73) Assignee: Sharp Kabushiki Kaisha, Osaka-shi, Osaka (JP)

(21) Appl. No.: 15/033,801

(22) PCT Filed: Jan. 26, 2015
(86) PCT No.: PCT/JP2015/052046

§ 371 Date: May 2, 2016

(30) Foreign Application Priority Data
Jan. 31, 2014 (JP) 2014-016468

(51) Int. Cl. A47J 31/42; A47J 31/52

(52) U.S. Cl. CPC A47J 31/42; A47J 31/52

(57) ABSTRACT

A beverage preparation apparatus prepares a beverage by mixing and agitating tea leaves and hot water. In the beverage preparation apparatus, a heater representing one example of a heating mechanism heats water. As a motor for milling which implements a grating mechanism drives, a mill grates food. In the beverage preparation apparatus, as a time period TD has elapsed since start of heating by the heater, drive of the motor for milling is started.

### TECHNICAL FIELD

The present disclosure relates to a beverage preparation apparatus and particularly to a beverage preparation apparatus including a grating mechanism for producing powders of food by grating the food and a heating mechanism for heating a liquid for preparing a beverage by mixing with the powders produced by the grating mechanism.

### BACKGROUND ART

Japanese Patent Laying-Open No. 2005-199242 (PTD 1) has conventionally proposed various techniques for an apparatus for preparing a beverage by making use of a grating mechanism obtaining a grated object by finely grating food with a mill. An apparatus having a heating mechanism for supplying hot water by heating water used for preparing a beverage, in addition to the grating mechanism, has also been proposed (for example, Japanese Patent Laying-Open No. 2001-275843 (PTD 2)).

### CITATION LIST

### Patent Document

### PTD 1: Japanese Patent Laying-Open No. 2005-199242

### PTD 2: Japanese Patent Laying-Open No. 2001-275843

### SUMMARY OF INVENTION

### Technical Problem

Since the beverage preparation apparatus including the grating mechanism and the heating mechanism as above does not require a user to separately prepare hot water for preparation of a beverage, it may be highly convenient. With a conventional beverage preparation apparatus, however, relation between timing of start of an operation of the grating mechanism and timing of start of an operation of the heating mechanism has not been studied in detail.

For example, when end of an operation of the grating mechanism is significantly later than end of an operation of the heating mechanism, a temperature of hot water provided by the heating mechanism may have already become low at the time of preparation of a beverage by mixing with a grated object provided by the grating mechanism.

The present disclosure was made in view of such circumstances, and an object thereof is to operate a grating mechanism and a heating mechanism at appropriate timing in a beverage preparation apparatus including the grating mechanism and the heating mechanism.

### Solution to Problem

According to one aspect, a beverage preparation apparatus for serving a beverage by mixing powders of food and a liquid is provided. The beverage preparation apparatus includes a grating mechanism for producing powders of food by grating the food, a heating mechanism for heating a liquid for preparing a beverage by mixing with the powders produced by the grating mechanism, and a control portion for controlling operations of the grating mechanism and the heating mechanism. The control portion starts heating of the liquid by the heating mechanism after a given time has elapsed since start of grating of the food by the grating mechanism.

Preferably, the given time is longer as an amount of the beverage served by the beverage preparation apparatus is greater.

Preferably, the given time is longer as a temperature at the beginning of heating of the liquid heated by the heating mechanism is higher.

Preferably, the grating mechanism includes a moving element for grating the food and a motor for driving the moving element, the beverage preparation apparatus further includes measurement means for measuring a temperature of the motor, and the control portion lowers driving force of the motor when a temperature measured with the measurement means exceeds a prescribed temperature.

Preferably, the grating mechanism includes a moving element for grating the food and a motor for driving the moving element, the beverage preparation apparatus further includes measurement means for measuring a rotation signal of the motor, and the control portion has grating of the food by the grating mechanism end when the rotation signal of the motor exceeds a certain value in grating of the food by the grating mechanism.

### Advantageous Effects of Invention

According to the present disclosure, a beverage preparation apparatus starts heating of a liquid after a prescribed time period has elapsed since start of grating of food. Thus, such a situation that a temperature of the liquid significantly lowers due to the heated liquid being left until end of grating of the food can be avoided.

### BRIEF DESCRIPTION OF DRAWINGS

FIG. 1 is an overall perspective view of a beverage preparation apparatus in a first embodiment.

FIG. 2 is a cross-sectional view along the line II-II in FIG. 1.

FIG. 3 is an overall perspective view showing a schematic component of the beverage preparation apparatus in the first embodiment.

FIG. 4 shows a first preparation flow showing discharge of Japanese tea using the beverage preparation apparatus in the first embodiment.

FIG. 5 shows a second preparation flow showing discharge of Japanese tea using the beverage preparation apparatus in the first embodiment.

FIG. 6 shows a third preparation flow showing discharge of Japanese tea using the beverage preparation apparatus in the first embodiment.

FIG. 7 is a perspective view showing only an internal structure of the beverage preparation apparatus in the first embodiment.

FIG. 8 is an enlarged view of a structure around a milling motor unit.

FIG. 9 is a perspective view of a milling unit in the first embodiment.

FIG. 10 is an exploded perspective view of the milling unit in the first embodiment.

FIG. 11 is a vertical cross-sectional view of the milling unit in the first embodiment.

FIG. 12 is an overall view showing a structure of a mill in the first embodiment.

FIG. 13 is a diagram showing a shape of a groove provided in a grinding surface of a lower mill in the first embodiment.

FIG. 14 is a cross-sectional view along the line XIV-XIV in FIG. 13.

FIG. 15 is a diagram showing an equiangular spiral in the shape of the groove in the first embodiment.

FIG. 16 is a view from above, which shows a shape of grooves provided in a grinding surface of an upper mill in the first embodiment.

FIG. 17 is a view from above, which shows a shape of grooves provided in a grinding surface of the lower mill in the first embodiment.

FIG. 18 is a view from above, which shows a state of the grinding surface including grooves provided in a mill in the first embodiment.

FIG. 19 is a view from above, which shows the state of the grinding surface including grooves provided in the mill in the first embodiment.

FIG. 20 is a view from above, which shows the state of the grinding surface including grooves provided in the mill in the first embodiment.

FIG. 21 is a view from above, which shows the state of the grinding surface including grooves provided in the mill in the first embodiment.

FIG. 22 is a plan view showing a shape of a groove provided in the lower mill in the first embodiment.

FIG. 23 is a cross-sectional view along the line XXIII-XXIII in FIG. 22.

FIG. 24 is a perspective view of an agitation unit in the present first embodiment.

FIG. 25 is a vertical cross-sectional view of the agitation unit in the first embodiment.

FIG. 26 is a diagram showing one example of a hardware configuration of the beverage preparation apparatus in the first embodiment.

FIG. 27 is a flowchart of processing corresponding to the “first preparation flow” described with reference to FIG. 4.

FIG. 28 is a diagram showing one example of a timing chart of operations in the beverage preparation apparatus in the first embodiment.

FIG. 29 is a flowchart of processing performed in the beverage preparation apparatus in a second embodiment.

FIG. 30 is a diagram schematically showing one example of information stored in a memory of the beverage preparation apparatus in the second embodiment.

FIG. 31 is a diagram schematically showing one example of relation among a time period TB, a time period TM, and a time period TD in the second embodiment.

FIG. 32 is a flowchart of processing performed in the beverage preparation apparatus in a third embodiment.

FIG. 33 is a diagram schematically showing one example of information stored in the memory of the beverage preparation apparatus in the third embodiment.

FIG. 34 is a diagram schematically showing one example of relation among a measured temperature, time period TB, time period TM, and time period TD in the third embodiment.

FIG. 35 is a diagram schematically showing relation between a temperature measured with a thermistor and the number of rotations of relative rotation in the mill in a fourth embodiment.

FIG. 36 is a diagram showing one example of variation in motor rotation signal with lapse of time in a grating operation and one example of variation in motor current value with lapse of time in the grating operation in the beverage preparation apparatus in a fifth embodiment.

FIG. 37 is a flowchart of processing performed in the beverage preparation apparatus in a sixth embodiment.

FIG. 38 is a diagram schematically showing one example of information stored in the memory of the beverage preparation apparatus in the sixth embodiment.

### DESCRIPTION OF EMBODIMENTS

A beverage preparation apparatus in the present disclosure will be described with reference to the drawings. In the drawings of the embodiments described below, the same or corresponding elements have the same reference numeral allotted and redundant description may not be repeated. When the number or an amount is mentioned in each embodiment, the scope of the present invention is not necessarily limited to the number or the amount unless otherwise specified.

### First Embodiment

In a first embodiment, though a case that tea leaves are used as an object to be grated and tea is prepared as a beverage will be described by way of example, the object to be grated is not limited to tea leaves, but the first embodiment can also be applied to preparation of a beverage with cereals, dried goods, and other objects to be grated.

Hereinafter, tea leaves mean a solid state before grating, powder tea leaves mean grated tea leaves, and tea means a beverage obtained by agitating (mixing) powder tea leaves and hot water.

(Beverage Preparation Apparatus 1)

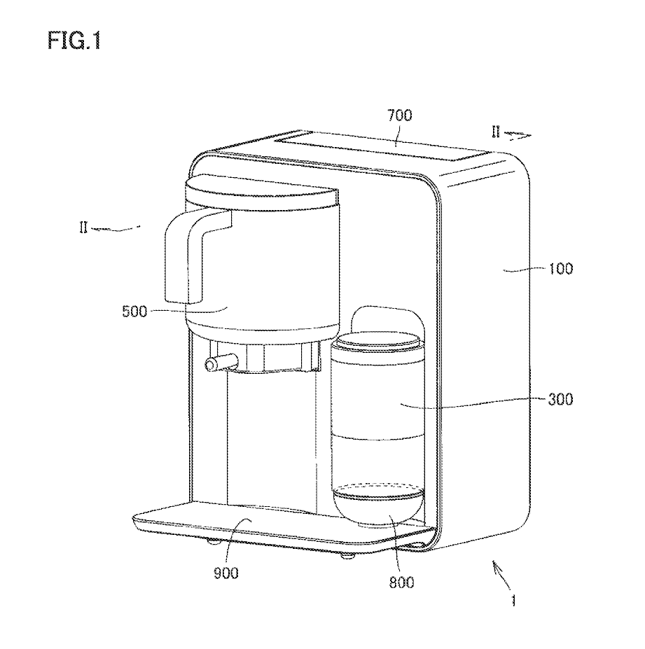

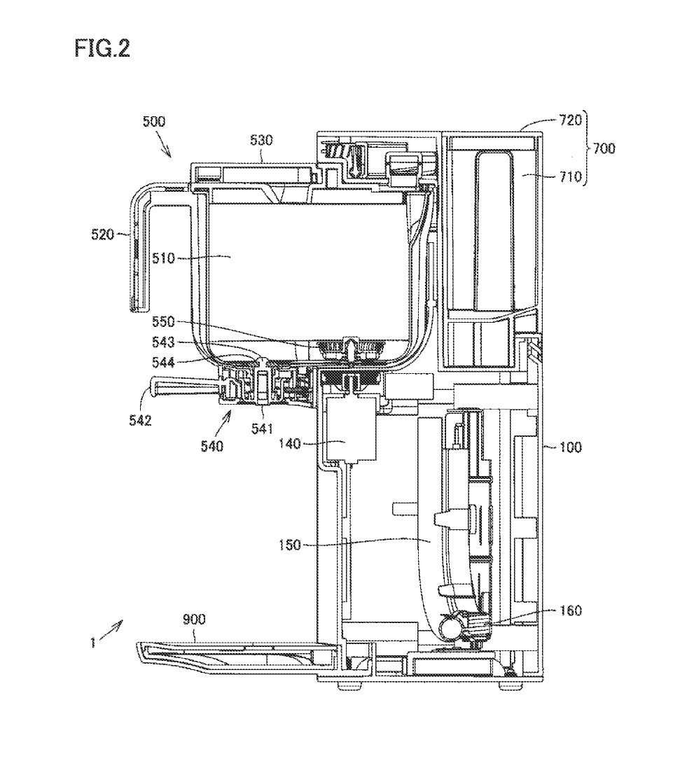

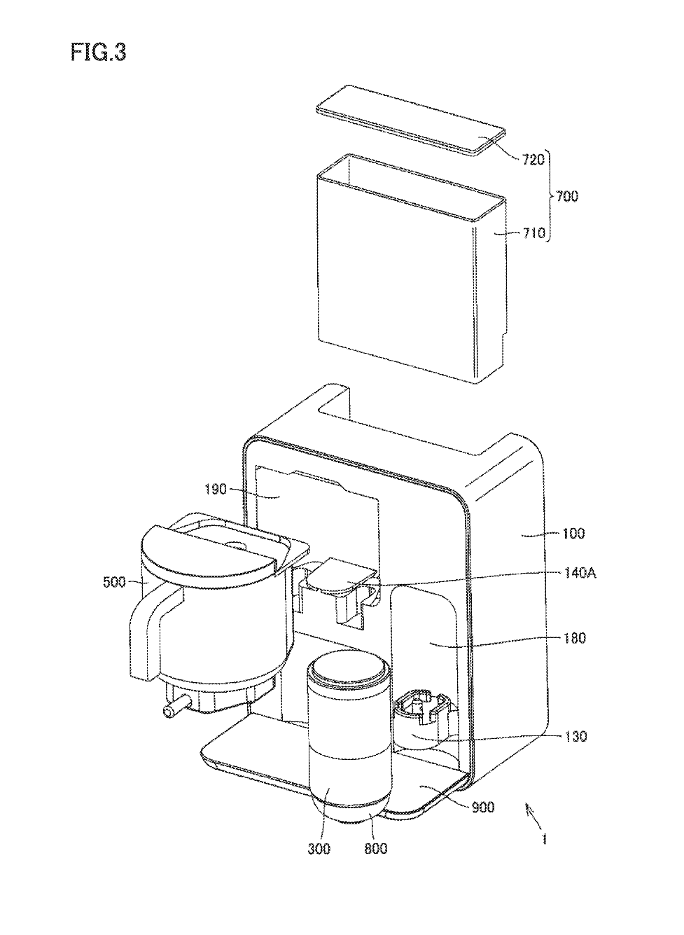

A beverage preparation apparatus 1 in the first embodiment will be described with reference to FIGS. 1 to 3. FIG. 1 is an overall perspective view of beverage preparation apparatus 1. FIG. 2 is a cross-sectional view along the line II-II in FIG. 1. FIG. 3 is an overall perspective view of a schematic component of beverage preparation apparatus 1.

Beverage preparation apparatus 1 uses tea leaves as an object to be grated and obtains tea leaf powders by grating the tea leaves. The beverage preparation apparatus uses the obtained tea leaf powders for preparing tea as a beverage. Beverage preparation apparatus 1 includes an apparatus main body 100, a milling unit 300, an agitation unit 500, a water tank 700, a tea leaf powder tray 800, and a placement base 900. Placement base 900 is provided to protrude forward on a front side in a lower portion of apparatus main body 100 and a cup (not shown) and tea leaf powder tray 800 can be placed thereon.

(Milling Unit 300)

Milling unit 300 is removably attached to a milling unit attachment region 180 provided on a front surface side of apparatus main body 100. A milling driving force coupling mechanism 130 is provided in milling unit attachment region 180 so as to protrude forward and milling unit 300 is removably attached to this milling driving force coupling mechanism 130. Milling unit 300 obtains driving force for milling tea leaves representing an object to be grated by being coupled to milling driving force coupling mechanism 130.

Tea leaves introduced from an upper portion of milling unit 300 into milling unit 300 are finely grated in milling unit 300, and dropped and collected as tea leaf powders on tea leaf powder tray 800 placed below milling unit 300.

(Agitation Unit 500)

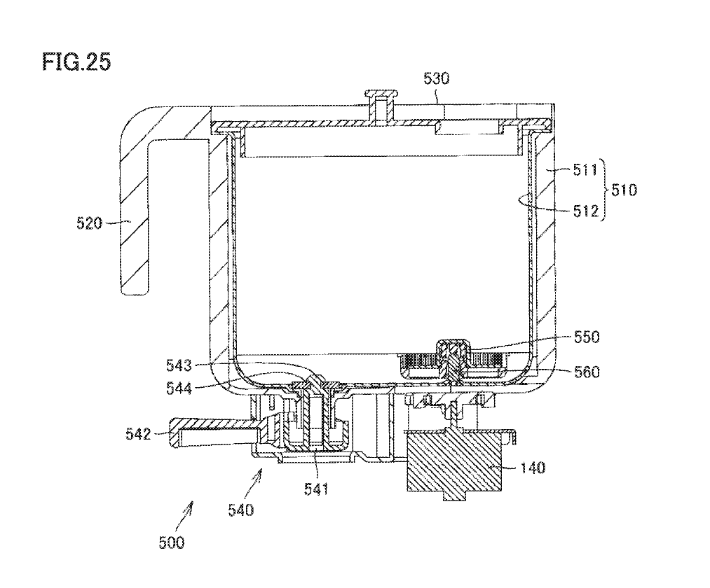

Agitation unit 500 is removably attached to an agitation unit attachment region 190 provided on the front surface side of apparatus main body 100. An agitation motor contactless table 140A is provided in agitation unit attachment region 190 and rotationally drives with magnetic force, an agitation blade 550 (see FIG. 25 which will be described later) provided in agitation unit 500.

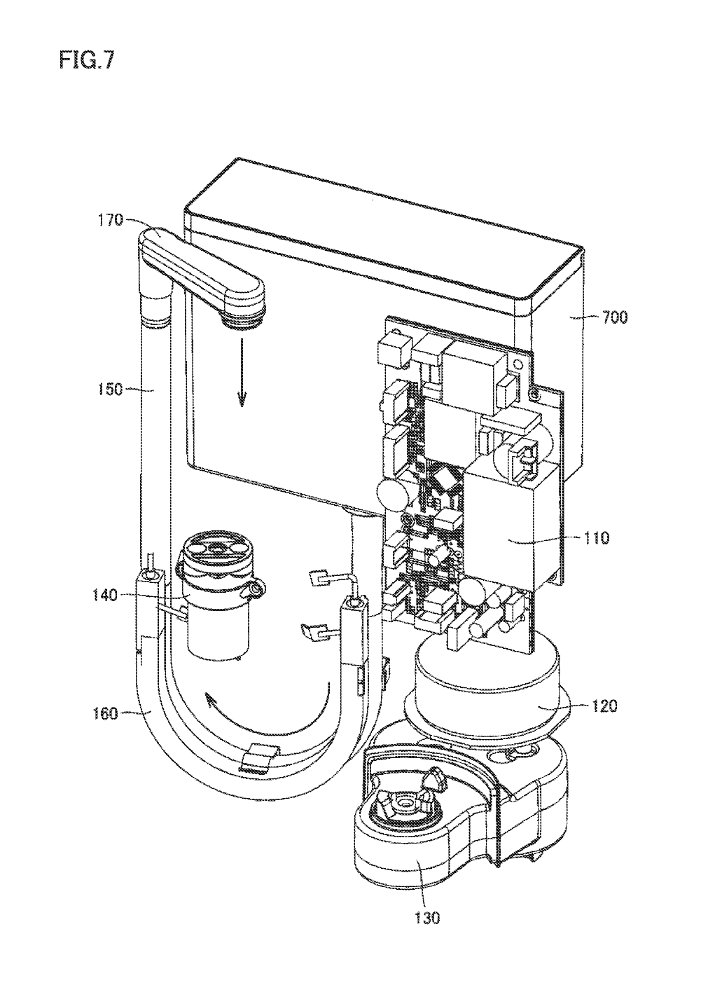

A hot water supply nozzle 170 (see FIG. 7) is provided above agitation unit attachment region 190 of apparatus main body 100. In apparatus main body 100, a temperature of water in water tank 700 is raised to a prescribed temperature and hot water is supplied from hot water supply nozzle 170 into an agitation tank 510. Hot water prepared in apparatus main body 100 and tea leaf powders obtained by milling unit 300 are introduced into agitation tank 510, and hot water and tea leaf powders are agitated by agitation blade 550 in agitation tank 510. Tea is thus prepared in agitation tank 510.

Japanese tea prepared in agitation unit 500 can be poured into a cup (not shown) placed on placement base 900 by operating an operation lever 542 of a discharge port opening and closing mechanism 540 provided below agitation unit 500.

(Flow of Preparation of Japanese Tea (Beverage))

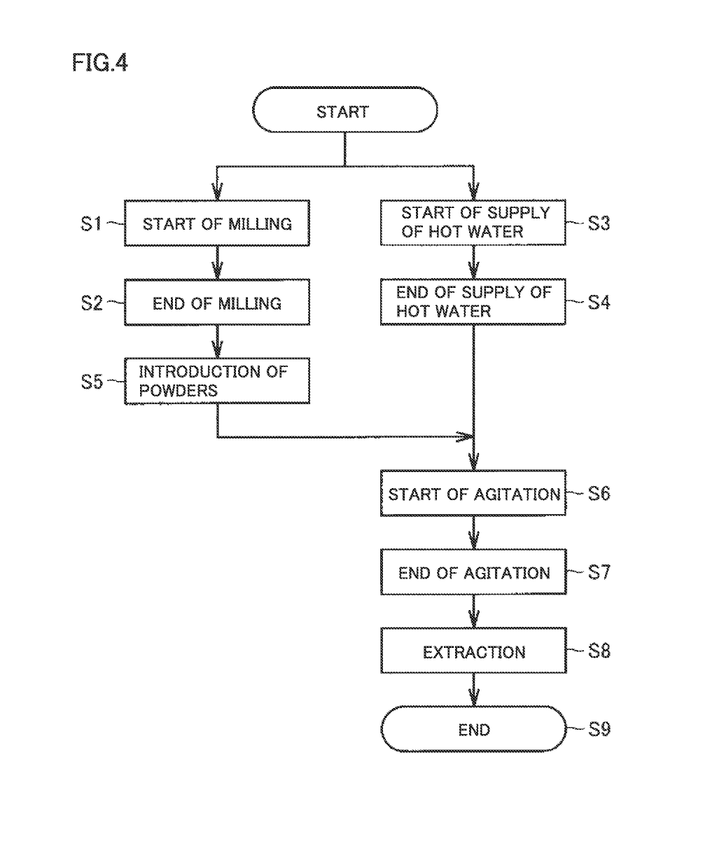

A flow of preparation of Japanese tea (beverage) with the use of beverage preparation apparatus 1 will now be described with reference to FIGS. 4 to 6. FIGS. 4 to 6 show first to third preparation flows showing discharge of Japanese tea using beverage preparation apparatus 1, respectively. A prescribed amount of Japanese tea leaves is introduced into milling unit 300 and a prescribed amount of water is stored in water tank 700.

(First Preparation Flow)

A first preparation flow will be described with reference to FIG. 4. This first preparation flow is a flow in which grating of tea leaves in milling unit 300 and supply of hot water from apparatus main body 100 to agitation unit 500 are simultaneously carried out.

In beverage preparation apparatus 1, milling of tea leaves by milling unit 300 in step S1 is started and supply of hot water from apparatus main body 100 to agitation unit 500 in step S3 is started. Then, milling of tea leaves by milling unit 300 ends in step S2, and supply of hot water from apparatus main body 100 to agitation unit 500 ends in step S4.

In step S5, tea leaf powders obtained in step 12 are introduced into agitation unit 500 by a user.

Then, in step S6, agitation of the tea leaf powders and hot water in agitation unit 500 is started. In step S7, agitation of the tea leaf powders and hot water in agitation unit 500 ends. In step S8, tea is discharged into a cup placed on placement base 900 as the user operates operation lever 542 of discharge port opening and closing mechanism 540 provided below agitation unit 500.

(Second Preparation Flow)

A second preparation flow will be described with reference to FIG. 5. This second preparation flow is a flow in which hot water is supplied from apparatus main body 100 to agitation unit 500 after tea leaves are grated in milling unit 300.

In beverage preparation apparatus 1, in step S1, milling of tea leaves by milling unit 300 is started. In step S2, milling of tea leaves by milling unit 300 ends. In step S3, tea leaf powders obtained in step S2 are introduced into agitation unit 500 by a user.

In step S4, supply of hot water from apparatus main body 100 to agitation unit 500 is started. In step S5, supply of hot water from apparatus main body 100 to agitation unit 500 ends.

Then, in step S6, agitation of the tea leaf powders and hot water in agitation unit 500 is started. In step S7, agitation of the tea leaf powders and hot water in agitation unit 500 ends. In step S8, tea is discharged into a cup placed on placement base 900 as the user operates operation lever 542 of discharge port opening and closing mechanism 540 provided below agitation unit 500.

(Third Preparation Flow)

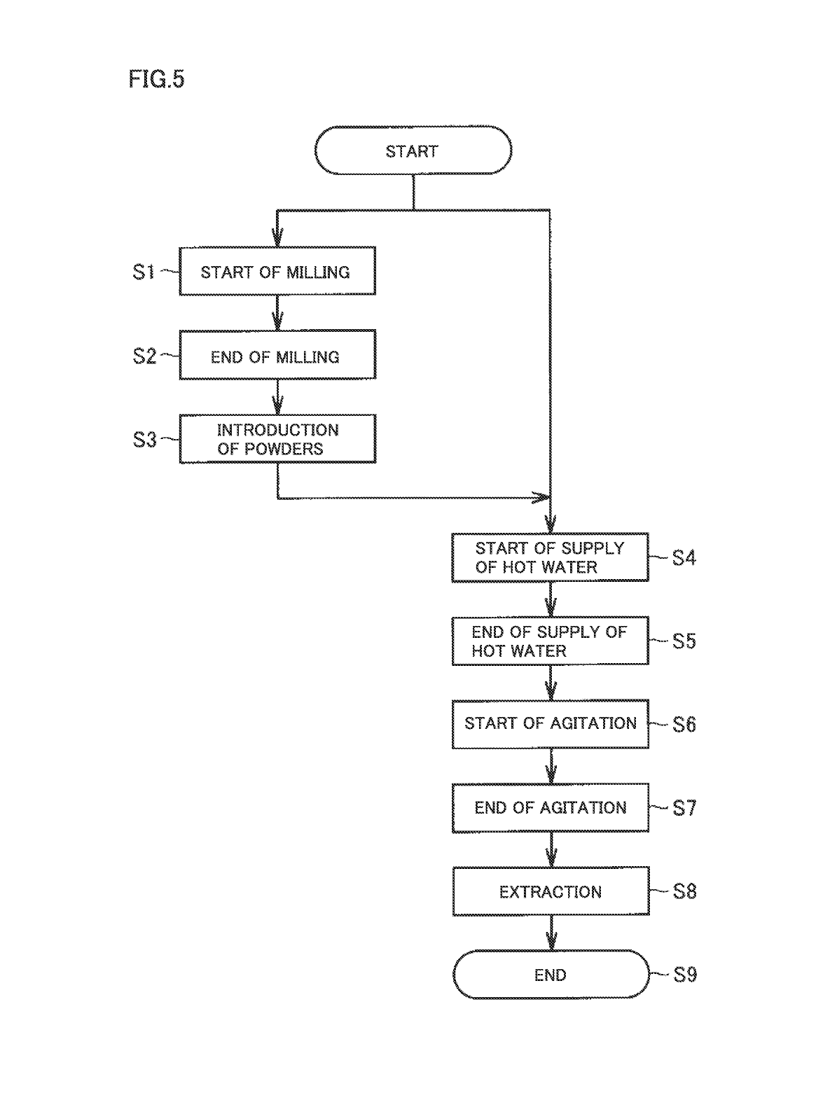

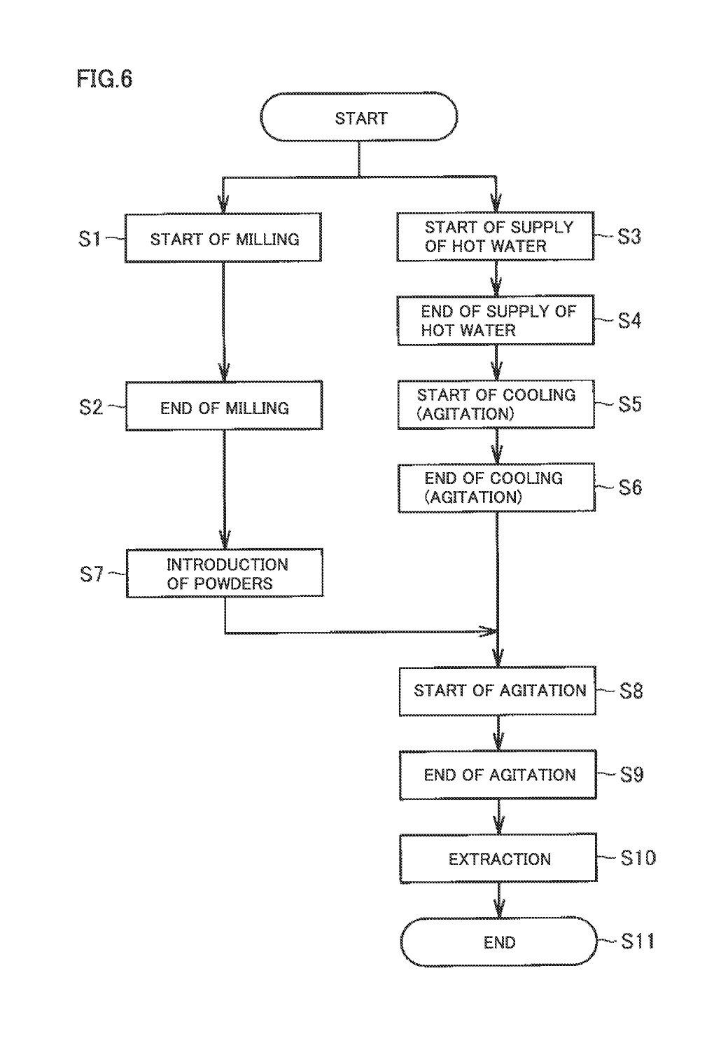

A third preparation flow will be described with reference to FIG. 6. This third preparation flow includes a step of cooling hot water by agitation in agitation unit 500.

In beverage preparation apparatus 1, milling of tea leaves by milling unit 300 in step S1 and supply of hot water from apparatus main body 100 to agitation unit 500 in step S3 are simultaneously started. In step S4, supply of hot water from apparatus main body 100 to agitation unit 500 ends.

Then, in step S2, milling of tea leaves by milling unit 300 ends, and in step S5, cooling by agitation of hot water supply is started in agitation unit 500. In step S6, cooling by agitation of hot water supply in agitation unit 500 ends.

Timing of end of milling and timing of end of agitation by cooling may be controlled to coincide with each other.

In step S7, the tea leaf powders obtained in step S2 are introduced into agitation unit 500 by a user.

Then, in step S8, agitation of the tea leaf powders and hot water in agitation unit 500 is started. In step S9, agitation of the tea leaf powders and hot water in agitation unit 500 ends. In a step 40, tea is discharged into the cup placed on placement base 900 as the user operates operation lever 542 of discharge port opening and closing mechanism 540 provided below agitation unit 500.

(Internal Structure of Apparatus Main Body 100)

An internal structure of beverage preparation apparatus 1 will now be described with reference to FIG. 7. FIG. 7 is a perspective view showing only the internal structure of beverage preparation apparatus 1. In apparatus main body 100 of beverage preparation apparatus 1, a control unit 110 including a printed circuit board on which electronic components are mounted is arranged on a front surface side of water tank 700. Based on input of a start signal by a user, the flow for preparation of tea is executed by control unit 110.

A milling motor unit 120 for providing driving force to milling unit 300 is arranged at a position below printed circuit board 110. Milling driving force coupling mechanism 130 provided to protrude forward for transmitting driving force of milling motor unit 120 to milling unit 300 is provided at a position below milling motor unit 120.

To a bottom surface of water tank 700, one end of a hot water supply pipe 150 extending once downward from the bottom surface and then extending upward in a U shape is coupled. Hot water supply nozzle 170 for pouring hot water into agitation tank 510 of agitation unit 500 is coupled to an upper end portion of hot water supply pipe 150. A U-shaped heater 160 for heating water which passes through hot water supply pipe 150 is attached to an intermediate region of hot water supply pipe 150.

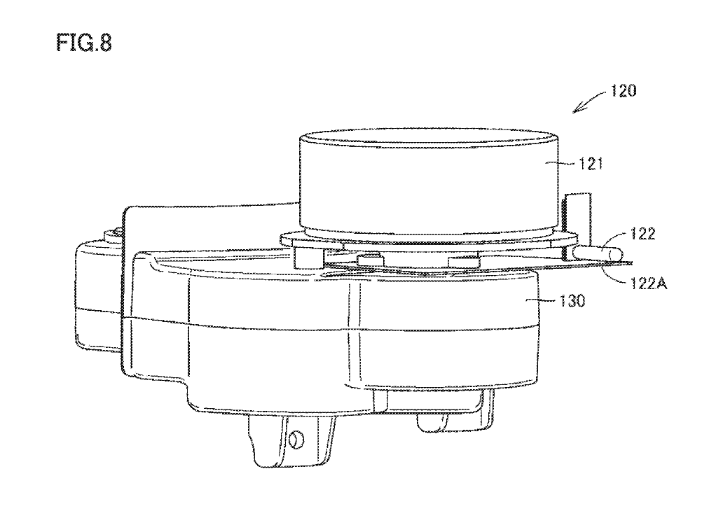

FIG. 8 is an enlarged view of a structure around milling motor unit 120. Referring to FIG. 8, milling motor unit 120 includes a motor for milling 121, a metal plate 122A for attaching motor for milling 121 to milling driving force coupling mechanism 130, and a thermistor 122 attached to metal plate 122A. Motor for milling 121 is attached to metal plate 122A. Heat conducts from motor for milling 121 to thermistor 122 through metal plate 122A. Thus, thermistor 122 can measure a temperature on an outer surface of motor for milling 121.

(Structure of Milling Unit 300)

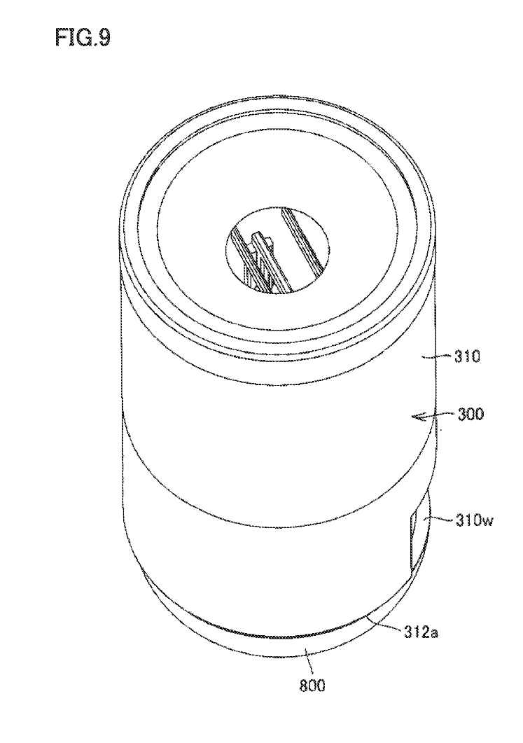

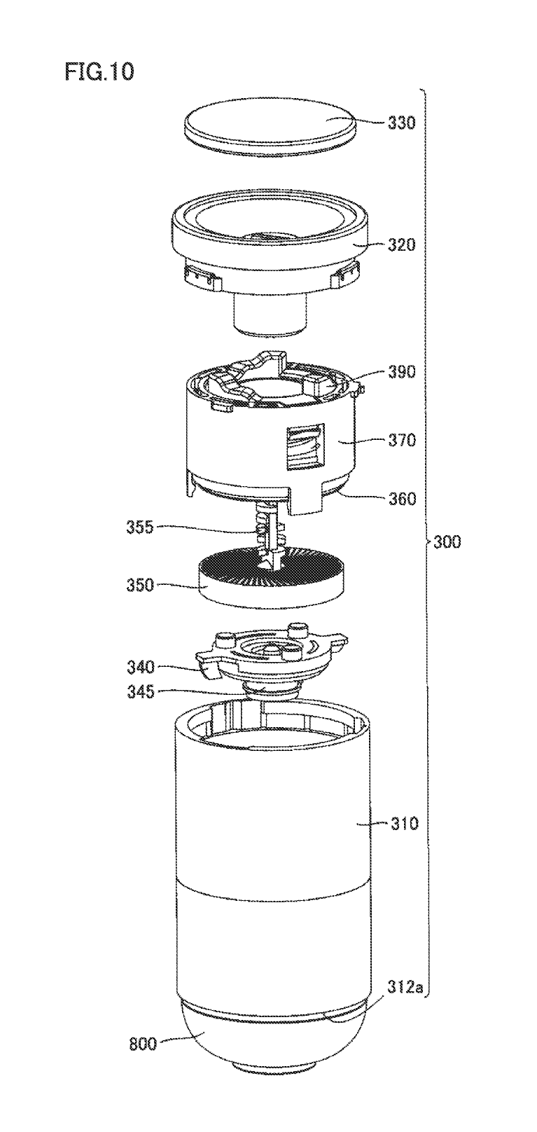

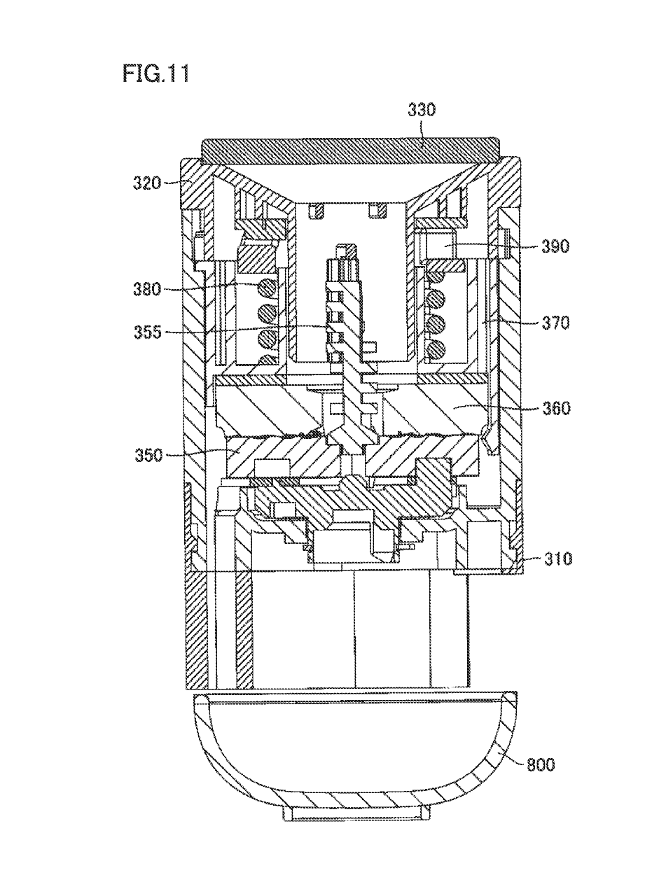

A structure of milling unit 300 will now be described with reference to FIGS. 9 to 11. FIG. 9 is a perspective view of milling unit 300. FIG. 10 is an exploded perspective view of milling unit 300. FIG. 11 is a vertical cross-sectional view of milling unit 300.

Milling unit 300 has a milling case 310 having a cylindrical shape as a whole, and a window 310w for coupling in which milling driving force coupling mechanism 130 is inserted is provided in a side surface below. An outlet port 312a is formed at a lowermost end portion of milling case 310 from which powders of tea leaves grated by milling unit 300 are taken out (drop).

A powder scraper 340, a lower mill 350, and an upper mill 360 are sequentially provided from below, in the inside of milling case 310. A milling shaft 345 extending downward is provided on a lower surface of powder scraper 340 and coupled to milling driving force coupling mechanism 130.

A core 355 extending upward along a core of a rotation shaft is provided in the central portion of lower mill 350. Upper mill 360 is held by an upper mill holding member 370, and a spring 380 and a spring holding member 390 pressing upper mill 360 downward are accommodated in upper mill holding member 370.

Core 355 provided in lower mill 350 protrudes upward to pass through upper mill 360.

(Mill 2)

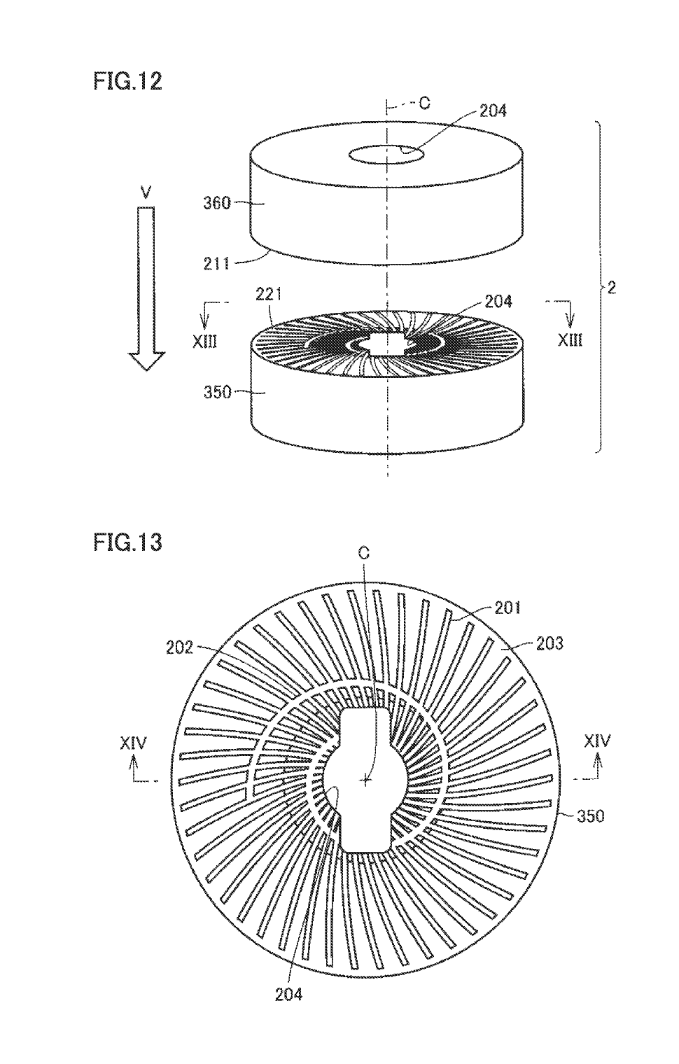

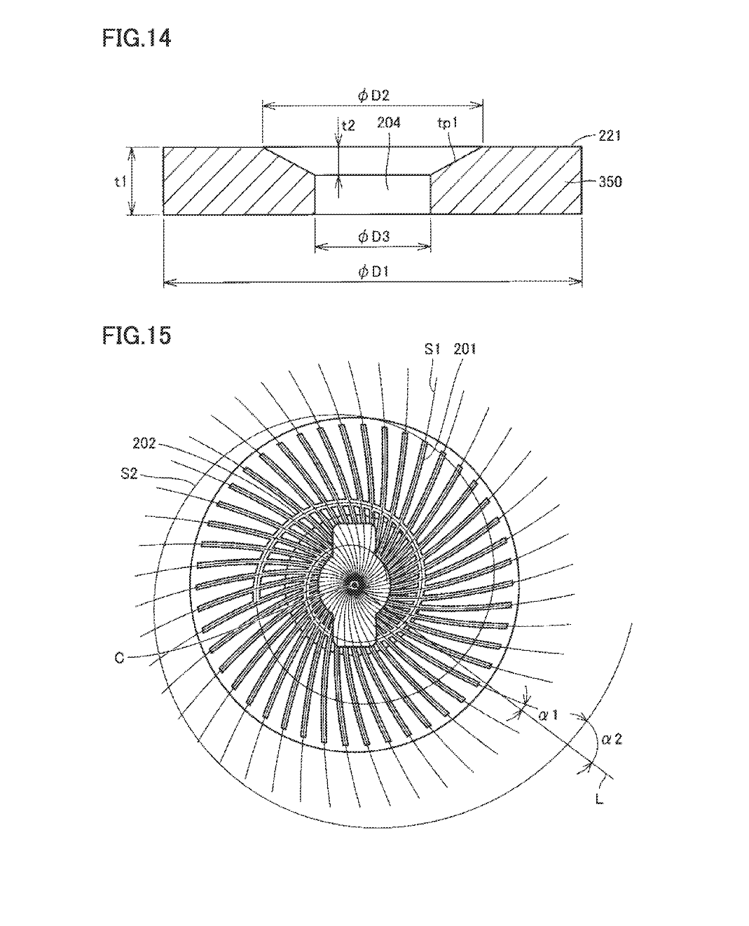

A mill 2 in the first embodiment based on the present invention will be described with reference to FIGS. 12 to 14. FIG. 12 is an overall view showing a structure of mill 2 in the first embodiment. FIG. 13 is a diagram showing a shape of grooves provided in a grinding surface of lower mill 350 in the first embodiment. FIG. 13 shows a view along the line XIII-XIII in FIG. 12. FIG. 14 is a cross-sectional view along the line XIV-XIV in FIG. 13.

Referring to FIG. 12, mill 2 in the first embodiment includes upper mill 360 provided with a grinding surface 211 and lower mill 350 provided with a grinding surface 221. Both of upper mill 360 and lower mill 350 have a disk shape. A center of rotation C is defined at a central portion of upper mill 360 and lower mill 350. Ceramics (alumina) is desirably employed as a material for upper mill 360 and lower mill 350.

Upper mill 360 and lower mill 350 in the first embodiment have a radius r approximately from 15 mm to 30 mm (a diameter φ D1 being 30 mm≦φ D1≦60 mm: see FIG. 14), and upper mill 360 and lower mill 350 have a thickness t1 around 8 mm. A relative rotation speed W of upper mill 360 and lower mill 350 is approximately 60 rpm≦W≦150 rpm. Thus, processing capability can be obtained based on a rotation speed in compensation for decrease in area of contact between the mills and reduction in necessary torque, and processing capability per necessary torque can thereby be enhanced rather than by increasing an area.

Referring to FIG. 13, a polished planar portion 203, a shear groove 201, and a feed groove 202 are formed in grinding surface 221 of lower mill 350. Similarly, polished planar portion 203, shear groove (a first groove portion) 201, and feed groove (a second groove portion) 202 are formed also in grinding surface 211 of upper mill 360.

As grinding surface 211 of upper mill 360 and grinding surface 221 of lower mill 350 are arranged to face each other, a groove provided in grinding surface 211 of upper mill 360 and a groove provided in grinding surface 221 of lower mill 350 are in relation of arrangement in point symmetry with respect to center of rotation C, when viewed along a direction shown with an arrow V in FIG. 12.

A plurality of shear grooves 201 are provided in rotation symmetry with respect to center of rotation C. Shear groove 201 is a groove for mainly grating an object to be grated and feed groove 202 is a groove for mainly feeding grated powders from a central portion of mill 2 to an outer circumferential portion.

A hole 204 including a key shape is opened in lower mill 350. Hole 204 has a diameter, for example, around 8 mm (φD3: see FIG. 14). Upper mill 360 is provided with hole 204 without a key shape. Core 355 (see FIG. 10) is attached to hole 204.

Referring again to FIG. 12, grinding surface 221 of lower mill 350 and grinding surface 211 of upper mill 360 abut to each other and rotate relatively to each other with center of rotation C being defined as a center of an axis of rotation. In the first embodiment, lower mill 350 having hole 204 including a key shape rotates around shaft 345 (see FIG. 10) described above, whereas upper mill 360 is fixed.

Referring to FIG. 14, in grinding surface 221 of lower mill 350, a tapered region tp1 is provided to include hole 204. Tapered region tp1 has an outer diameter (φ D2) around 20 mm and hole 204 has a depth t2 approximately from 2 mm to 3 mm. Similar tapered region tp1 is provided also in upper mill 360.

Grinding surface 221 of lower mill 350 and grinding surface 211 of upper mill 360 are superimposed on each other, so that a space surrounded by tapered region tp1 is formed. Thus, for example, even when tea leaves are introduced as an object to be grated, the tea leaves can satisfactorily be guided from this space to the grinding surface.

An equiangular spiral along which shear groove 201 and feed groove 202 extend will be described with reference to FIGS. 15 to 21. FIG. 15 is a diagram showing an equiangular spiral along which the shape of the groove extends in the first embodiment.

FIG. 16 is a view from above, which shows a shape of grooves provided in the grinding surface of the upper mill in the first embodiment. FIG. 17 is a view from above, which shows a shape of grooves provided in the grinding surface of the lower mill in the first embodiment. FIGS. 18 to 21 are views from above, which show states of the grinding surface including grooves provided in the mill in the first embodiment, with an angle of rotation being set to 0, 10°, 20°, and 30°, respectively.

Referring to FIG. 15, shear groove 201 is formed along an equiangular spiral S1, and feed groove 202 is formed along an equiangular spiral S2. With center of rotation C being defined as the origin, equiangular spiral S (S1 and S2) is expressed in an expression 1 below with parameters a and b.

S=a·exp(b·θ) (Expression 1)

An angle α (α1 and α2) formed between a half line L extending from center of rotation C and an equiangular spiral is expressed in an expression 2 below.

α=arccot(b) (Expression 2)

Equiangular spiral S1 suitable for shear groove 201 is defined by a=5 and b=0.306 in (Expression 1) and α=17.0° in (Expression 2). In practice, angle α1 formed between half line L and equiangular spiral S1 (shear groove 201) is desirably 0°<α1<45°, preferably 10°≦α1≦20°, and further preferably α1=17.0°.

Equiangular spiral S2 suitable for feed groove 202 is defined by a=5 and b=3.7 in (Expression 1) and α=74.9° in (Expression 2). In practice, angle α2 formed between half line L and equiangular spiral S2 (feed groove 202) is desirably 45°<α2<90°, preferably 70° α2≦80°, and further preferably α2=74.9°.

Here, mathematic properties of an equiangular spiral expressed in (Expression 1) are that angles α formed between half line L extending from center of rotation C and equiangular spirals S1 and S2 are always constant. Therefore, when rotation is carried out with grinding surface 211 of upper mill 360 and grinding surface 221 of lower mill 350 abutting to each other, an angle of intersection between the groove (shear groove 201 and feed groove 202) in upper mill 360 and the groove (shear groove 201 and feed groove 202) in lower mill 350 is always 2α.

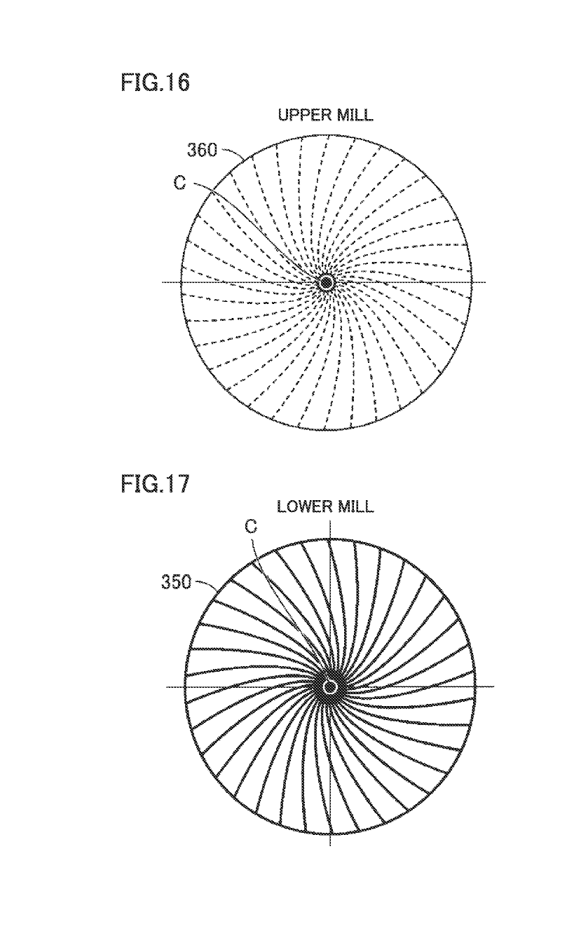

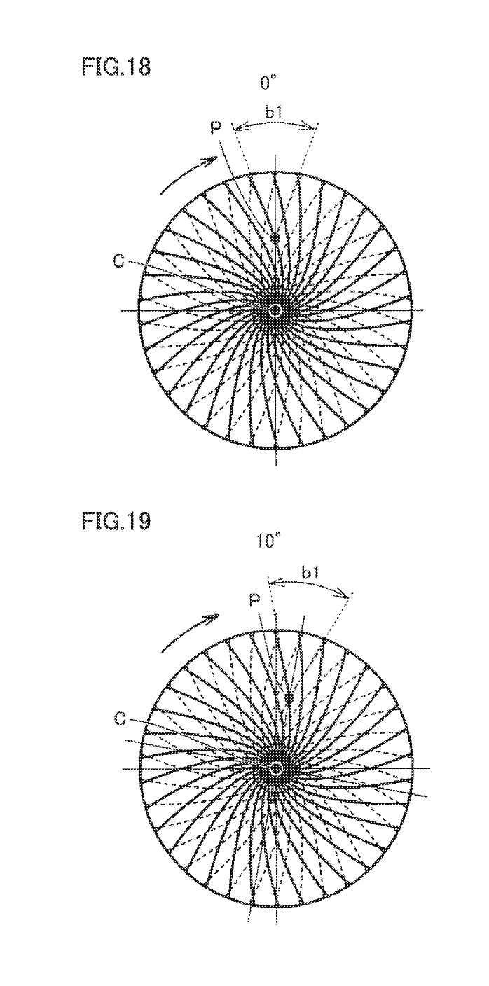

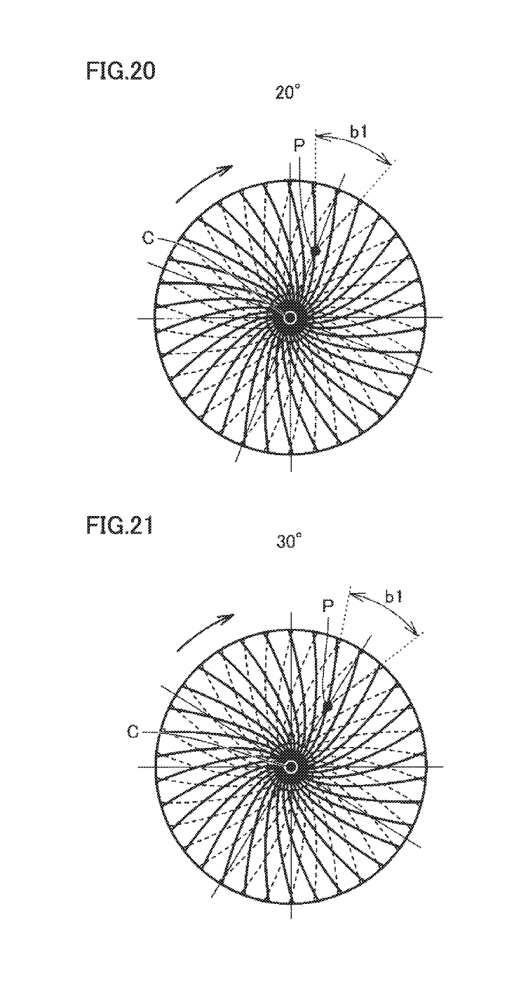

FIGS. 16 to 21 show an angle of intersection between the grooves in upper mill 360 and lower mill 350 in the first embodiment. FIGS. 18 to 21 show observation of the grinding surface from an upper surface of upper mill 360. More specifically, with an initial state 0° (FIG. 18) being defined as the reference, rotation of upper mill 360 and lower mill 350 relative to each other by 10° (FIG. 19), 20° (FIG. 20), and 30° (FIG. 21) is shown.

An angle of intersection at a point of intersection P between the groove in upper mill 360 and the groove in lower mill 350 is always constant at b1. An amount of movement of the point of intersection outward is smaller than an amount of movement in the background art. Therefore, by providing an appropriate angle of intersection, a desired shearing function can be provided at the time of intersection between edges of the grooves.

Though FIGS. 16 to 21 show only shear groove 201 in FIG. 13 for the sake of convenience of description, feed groove 202 formed along the equiangular spiral is also similar to shear groove 201.

Grating of an object by grinding between grinding surface 211 of upper mill 360 of mill 2 and grinding surface 221 of lower mill 350 may be by shear mainly resulting from intersection between edges of the grooves. There is an angle of intersection between grooves optimal for shear, and at an optimal angle of intersection between grooves, force applied to edges, that is, rotation torque, can be lowered. According to tests, an angle of intersection suitable for shear was approximately 30°. When an angle of intersection is obtuse, an object is fed toward an outer circumference through the groove without substantially being grated. According to the tests, an angle of intersection suitable for feeding was approximately 150°.

A feeding speed and a grain size of powders discharged after grating relate to each other. A higher feeding speed leads to a coarse grain size, and a lower feeding speed leads to a fine grain size. The number of feed grooves and an angle can be optimized in order to obtain a desired grain size. A desired grain size in the first embodiment is approximately 10 μm in grating of tea leaves. Though a single feed groove 202 is provided in the first embodiment, a plurality of feed grooves 202 may be provided in rotation symmetry with respect to center of rotation C, depending on a desired grain size and other parameters.

In mill 2 in the first embodiment, an angle of intersection between groove portions in the upper mill and the lower mill is always constant with rotation of upper mill 360 and lower mill 350 relative to each other, so that a condition more suitable for grating can be provided to an object to be grated and grating capability per unit area can be improved.

Furthermore, since an angle of intersection between the grooves in the upper mill and the lower mill is always constant and an angle of intersection mainly contributing to shear of an object to be grated and an angle of intersection mainly contributing to feeding of the object to be grated can be provided in relative rotation, grating capability and processing capability per unit area can be improved. Mill 2 including a shape of grooves along an equiangular spiral in the first embodiment exhibited processing capability at least twice as high as that of a mill having a shape of grooves in the background art.

Furthermore, a more suitable angle of intersection mainly contributing to shear of an object to be grated can be provided and rotation torque necessary during grating can be lowered. An optimal angle of shear is provided by α1 and a feeding speed for obtaining a desired grain size can be optimized by α2.

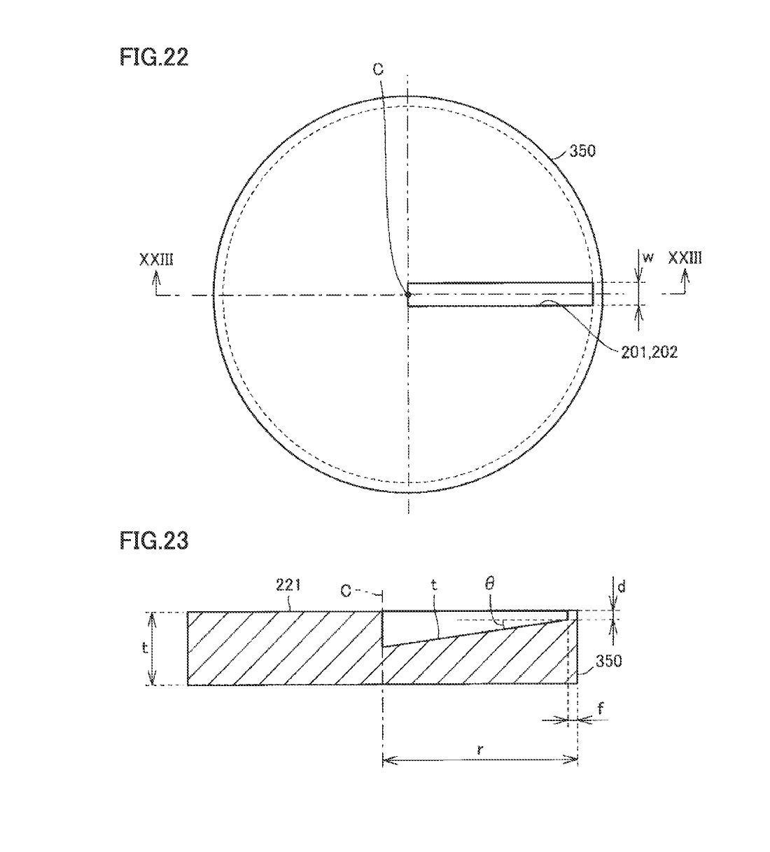

An embodiment relating to a shape of grooves provided in lower mill 350 and upper mill 360 will now be described with reference to FIGS. 22 and 23. FIG. 22 is a plan view showing a shape of a groove provided in lower mill 350 in the first embodiment. FIG. 23 is a cross-sectional view along the line XXIII-XXIII in FIG. 22. Since a groove the same as in lower mill 350 is formed also in upper mill 360, description in connection with upper mill 360 will not be provided.

A speed of passage of powders through a groove is higher as a width of the groove is smaller and a depth of the groove is smaller. A parameter for forming a groove which is particularly suitable for grating of tea leaves has not yet been disclosed. According to FIGS. 22 and 23, groove 201 (202) formed in the grinding surface of lower mill 350 has a width w desirably from 0.5 mm w 1.5 mm.

Width w of groove 201 (202) means width w along a direction orthogonal to a direction of extension of groove 201 (202). By setting width w of groove 201 (202) to 0.5 mm≦w≦1.5 mm, ease in cleaning of powders in groove 201 (202) can be ensured while a feeding speed in grating of tea leaves is ensured.

A depth of the groove of d mm is preferably ensured on an outermost circumferential side. Furthermore, a flat portion f where no groove is present is desirably provided around the entire circumference of an edge portion at an outermost circumference on a half line extending from center of rotation C of the grinding surface. Desirably, d is approximately 0.1 mm≦d≦1 mm and f is not smaller than 0.5 mm.

By thus pooling powders in the groove and restricting discharge thereof, powders having a desired grain size can be obtained also with a small area (a length of a path of a groove).

Depth d of the groove desirably has an inclined surface t increasing in depth toward center of rotation C. Thus, a depth can be provided from the center of rotation toward the outer circumference in accordance with a grain size in grating, and a speed at which powder particles in one groove advance can substantially be constant. An angle of inclination θ of inclined surface t with respect to the grinding surface is desirably approximately 2.3°≦θ≦4.5°.

In the first embodiment, lower mill 350 has radius r approximately from 15 mm to 30 mm and has thickness t of approximately 8 mm. By using mill 2 having lower mill 350 and upper mill 360, a result of a grain size around 10 μm was obtained in a test of grating of tea leaves.

A shape of the groove portions for an object to be grated, in particular for tea leaves, can suitably be provided, and a desired grain size can be obtained in a limited area, that is, a length of a path of the groove, by suppressing a speed of discharge of powders toward the outer circumference. Therefore, an area of a mill can be decreased and reduction in size of a product and lowering in necessary torque can be achieved.

Regarding a parameter for a shape of grooves included in the mill in the first embodiment, a shape of the grooves is not limited to the shape of the grooves along the equiangular spiral described above. For example, the parameters are applicable also to a groove portion extending substantially along a straight line in rotation symmetry with respect to center of rotation C from center of rotation C toward the outer circumference. In this case as well, powders having a desired grain size can be obtained, and a speed at which powder particles in a single groove advance can substantially be constant. Even grooves in a linear shape as in the background art could obtain a result of a grain size around 10 μm in a test of grating of tea leaves.

Specifically, in a mill having an upper mill and a lower mill each provided with a grinding surface, the grinding surface includes linear grooves extending from a center of rotation toward an outer circumference, a flat portion where no groove is present is provided around the entire circumference of an outermost circumferential edge portion of the grinding surface, width w along a direction orthogonal to a direction of extension of a groove portion is within a range of 0.5 mm≦w≦1.5 mm, the groove portion has an inclined surface increasing in depth toward the center of rotation, a depth d from the grinding surface on the outermost circumferential side of the inclined surface is within a range of 0.1 mm d 1 mm, and an angle of inclination θ of the inclined surface with respect to the grinding surface is 2.3°≦θ≦4.5°.

Thus, with a conventional shape of grooves, a shape of groove portions for an object to be grated, in particular for tea leaves, can suitably be provided, and a desired grain size can be obtained within a limited area, that is, a length of a path of a groove, by suppressing a speed of discharge of powders toward the outer circumference. Therefore, an area of a mill can be decreased and reduction in size of a product and lowering in necessary torque can be achieved.

(Structure of Agitation Unit 500)

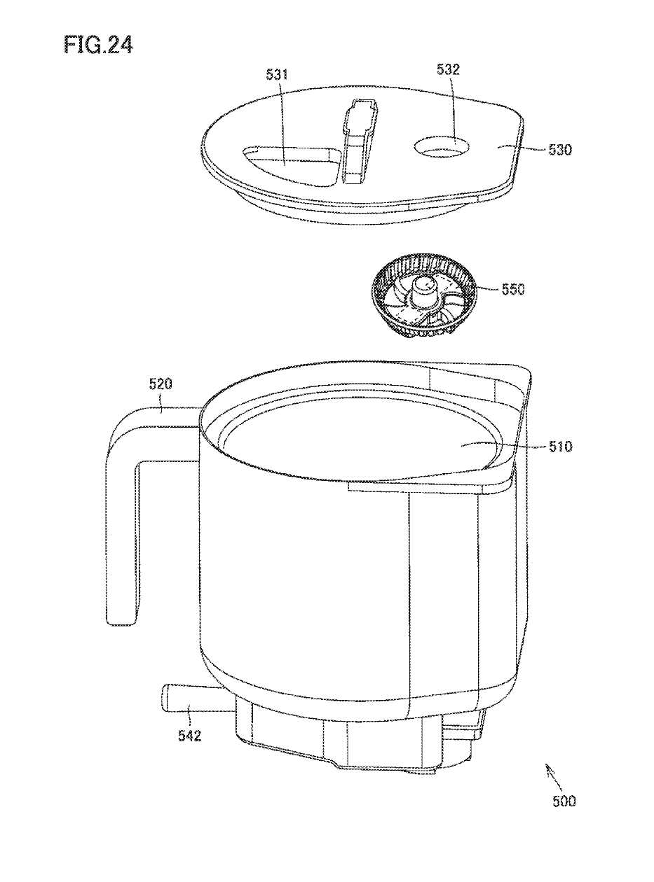

A structure of agitation unit 500 will now be described with reference to FIGS. 24 and 25. FIG. 24 is a perspective view of agitation unit 500. FIG. 25 is a vertical cross-sectional view of agitation unit 500.

Agitation unit 500 includes agitation tank 510. Agitation tank 510 includes an exterior holder 511 made of a resin and a thermally insulated tank 512 held by this exterior holder 511. An integrally resin molded grip 520 is provided in exterior holder 511. Over an upper opening of agitation tank 510, an agitation cover 530 opening and closing the opening is provided. Agitation cover 530 is provided with a powder inlet 531 through which tea leaf powders grated by milling unit 300 are introduced and a hot water supply inlet 532 formed in apparatus main body 100, through which hot water is poured from hot water supply nozzle 170.

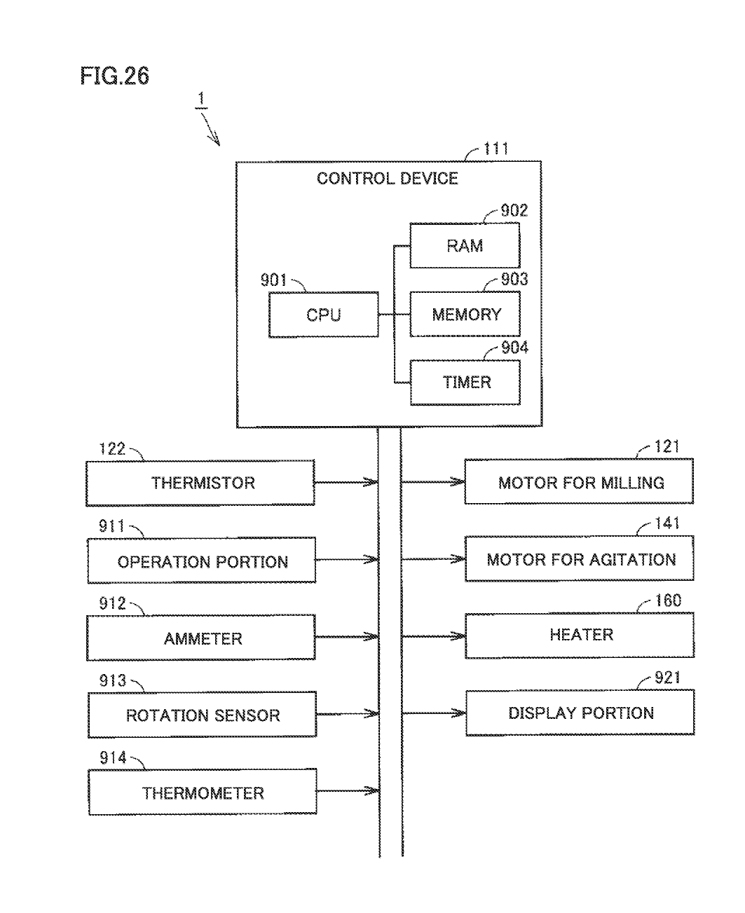

Agitation blade 550 is placed on a bottom portion of agitation tank 510. Agitation unit 500 further includes an agitation motor unit 140 including a motor for agitation 141 (see FIG. 26) for rotating agitation blade 550. A rotation shaft 560 extending upward is provided on the bottom portion of agitation tank 510, and a bearing portion 551 for agitation blade 550 is inserted in this rotation shaft 560.

A magnet is embedded in agitation blade 550. In agitation motor contactless table 140A, the magnet embedded in agitation blade 550 and a magnet provided on a side of agitation motor unit 140 are magnetically coupled in a contactless state, so that rotational driving force of agitation motor unit 140 is transmitted to agitation blade 550.

A discharge port 541 for discharging agitated tea is provided in the bottom portion of agitation tank 510. Discharge port opening and closing mechanism 540 is provided at discharge port 541. Discharge port opening and closing mechanism 540 includes an opening and closing nozzle 543 inserted into discharge port 541 so as to be able to open and close discharge port 541 and operation lever 542 controlling a position of opening and closing nozzle 543. Opening and closing nozzle 543 is biased to close discharge port 541 by a biasing member (not shown) such as a spring in a normal state. When a user moves operation lever 542 against biasing force, opening and closing nozzle 543 moves to open discharge port 541 and thus tea in agitation tank 510 is poured into a cup (not shown) placed on placement base 900.

(Hardware Configuration)

FIG. 26 is a diagram showing one example of a hardware configuration of beverage preparation apparatus 1 in the first embodiment. As shown in FIG. 26, beverage preparation apparatus 1 includes a control device 111 for controlling an operation of beverage preparation apparatus 1. In beverage preparation apparatus 1 in the first embodiment, control device 111 is located in control unit 110 (see FIG. 7). Arrangement of control device 111 is not limited as such.

Control device 111 includes a central processing unit (CPU) 901 for control by execution of a program, a random access memory (RAM) 902 functioning as a work area for CPU 901, a memory 903 for non-transitory storage of data such as a program, and a timer 904. Memory 903 is implemented, for example, by an electrically erasable programmable read-only memory (EEPROM).

Control device 111 is connected to thermistor 122, motor for milling 121, motor for agitation 141, and heater 160 through a bus. Beverage preparation apparatus 1 further includes an operation portion 911, an ammeter 912, a rotation sensor 913, a thermometer 914, and a display portion 921.

Operation portion 911 is operated for inputting information to CPU 901 and provided, for example, in an outer shell portion of beverage preparation apparatus 1. Operation portion 911 is implemented, for example, by a plurality of buttons. Ammeter 912 measures a current value in motor for milling 121 and inputs the current value to CPU 901. Rotation sensor 913 measures a rotation signal of motor for milling 121 and inputs the rotation signal to CPU 901. Thermometer 914 measures a temperature of water stored in water tank 700 (or water in hot water supply pipe 150) and inputs the temperature to CPU 901. Thermometer 914 is provided, for example, on an inner surface of a cover of beverage preparation apparatus 1 so as to measure a temperature at a portion exhibiting a temperature which can be close to a temperature of water in water tank 700. Display portion 921 is provided to output information to the outside of beverage preparation apparatus 1. Display portion 921 is implemented, for example, by a plurality of indicators. CPU 901 gives a notification of end of grating of an object to be grated by turning on a prescribed indicator in display portion 921.

(Control Flow)

A specific control flow for grating of tea leaves and supply of hot water to agitation unit 500 in beverage preparation apparatus 1 will now be described.

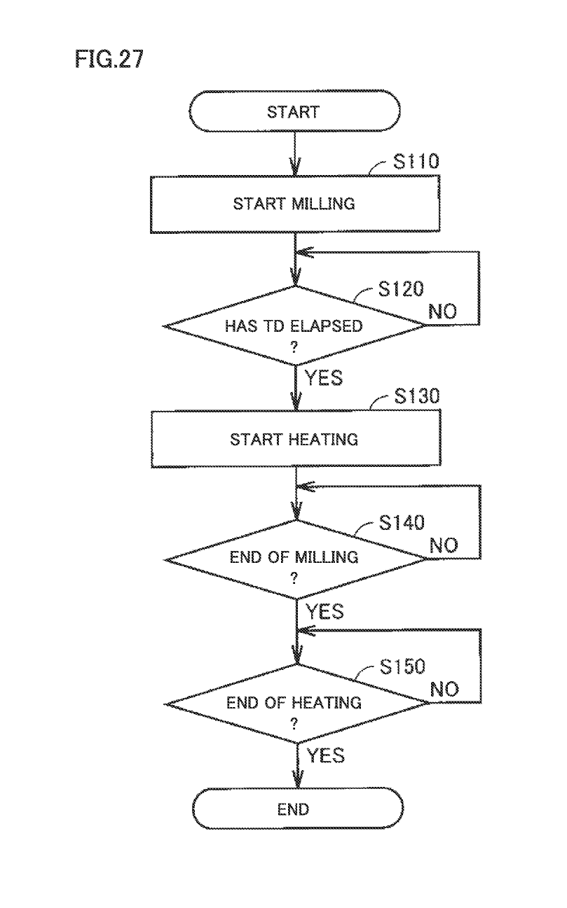

FIG. 27 is a flowchart of processing corresponding to the “first preparation flow” described with reference to FIG. 4. According to the processing in FIG. 27, in preparation of a beverage by beverage preparation apparatus 1, initially, milling by milling unit 300 is started, and heating of water by heater 160 is started after a time period TD. The processing in FIG. 27 is started, for example, in response to an operation of a start button which is a part of operation portion 911. Contents of the processing will be described below.

Referring to FIG. 27, in step S110, CPU 901 starts milling by milling unit 300. Specifically, CPU 901 starts relative rotation of upper mill 360 and lower mill 350, by allowing power supply to motor for milling 121.

Then, in step S120, CPU 901 determines whether or not time period TD has elapsed since start of milling in step S110. When CPU 901 determines that time period TD has elapsed (YES in step S120), control proceeds to step S130.

In step S130, CPU 901 starts heating of water in hot water supply pipe 150 (specifically, control for power supply to heater 160).

Then, CPU 901 determines in step S140 whether or not milling has ended. In beverage preparation apparatus 1, milling (drive by motor for milling 121) ends after milling has continued for a predetermined time period since start of milling. Then, when CPU 901 determines that milling has ended (YES in step S140), control proceeds to step S150. CPU 901 may give a notification of end of milling with display portion 921.

In step S150, CPU 901 determines whether or not heating of water in hot water supply pipe 150 which had been started in step S130 has ended. Beverage preparation apparatus 1 is configured such that heating by heater 160 ends on condition that a temperature in hot water supply pipe 150 has reached a prescribed temperature. More specifically, beverage preparation apparatus 1 is provided with a thermocouple which can operate based on a temperature in hot water supply pipe 150. When there is no water in hot water supply pipe 150 and a prescribed temperature is reached, the thermocouple stops power supply to heater 160. When CPU 901 determines that heating by heater 160 has ended (YES in step S150), it quits the processing shown in FIG. 27. CPU 901 may give a notification of end of heating with display portion 921.

In the first embodiment, a grating mechanism is implemented by motor for milling 121 and mill 2 and a heating mechanism is implemented by heater 160. In the processing shown in FIG. 27, heating of water in hot water supply pipe 150 by heater 160 is started when time period TD has elapsed since start of drive of motor for milling 121. Thus, significant lowering in temperature of water in agitation tank 510 by the time of end of grating of tea leaves by milling motor unit 120 due to water in agitation tank 510 being left after the end of heating by heater 160 can be avoided.

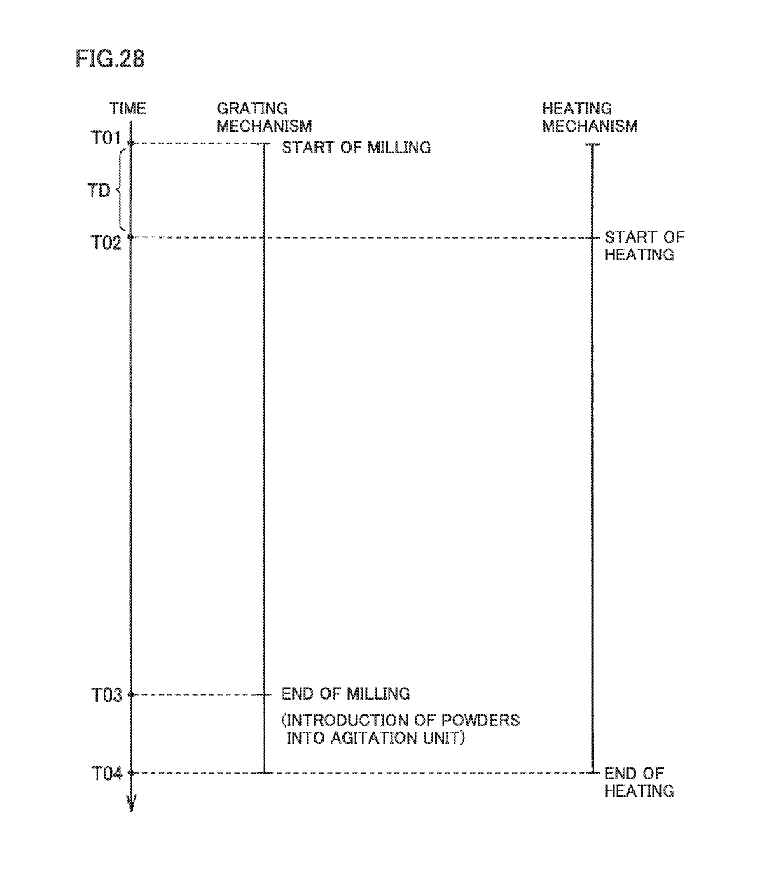

FIG. 28 is a diagram showing one example of a timing chart of operations in beverage preparation apparatus 1 in the first embodiment. Referring to FIG. 28, when the processing in FIG. 27 is started, milling (grating of tea leaves) is started at time T01. After time period TD has elapsed since time T01, that is, at time T02, heating by heater 160 is started. Thereafter, grating of tea leaves ends at time T03. Thereafter, heating of water in hot water supply pipe 150 ends at time T04.

Thereafter, a user introduces tea leaf powders obtained by milling unit 300 into agitation unit 500. Then, as the user operates a specific button of operation portion 911, agitation by agitation unit 500 is started.

The timing chart shown in FIG. 28 is merely by way of example. Heating of water in hot water supply pipe 150 may end earlier than or simultaneously with grating of tea leaves by milling unit 300.

### Second Embodiment

A hardware configuration of beverage preparation apparatus 1 in a second embodiment can be the same as in the first embodiment. In beverage preparation apparatus 1 in the second embodiment, a time period required for grating of tea leaves by milling unit 300 can be varied. More specifically, beverage preparation apparatus 1 accepts setting as to how many servings should be prepared at a time. In beverage preparation apparatus 1, depending on contents of the setting, a time period required for grating of tea leaves by milling unit 300 and a time period required for heating of water in hot water supply pipe 150 by heater 160 are varied. In response, in beverage preparation apparatus 1, a length of time period TD from start of grating of tea leaves until start of heating of water is also varied.

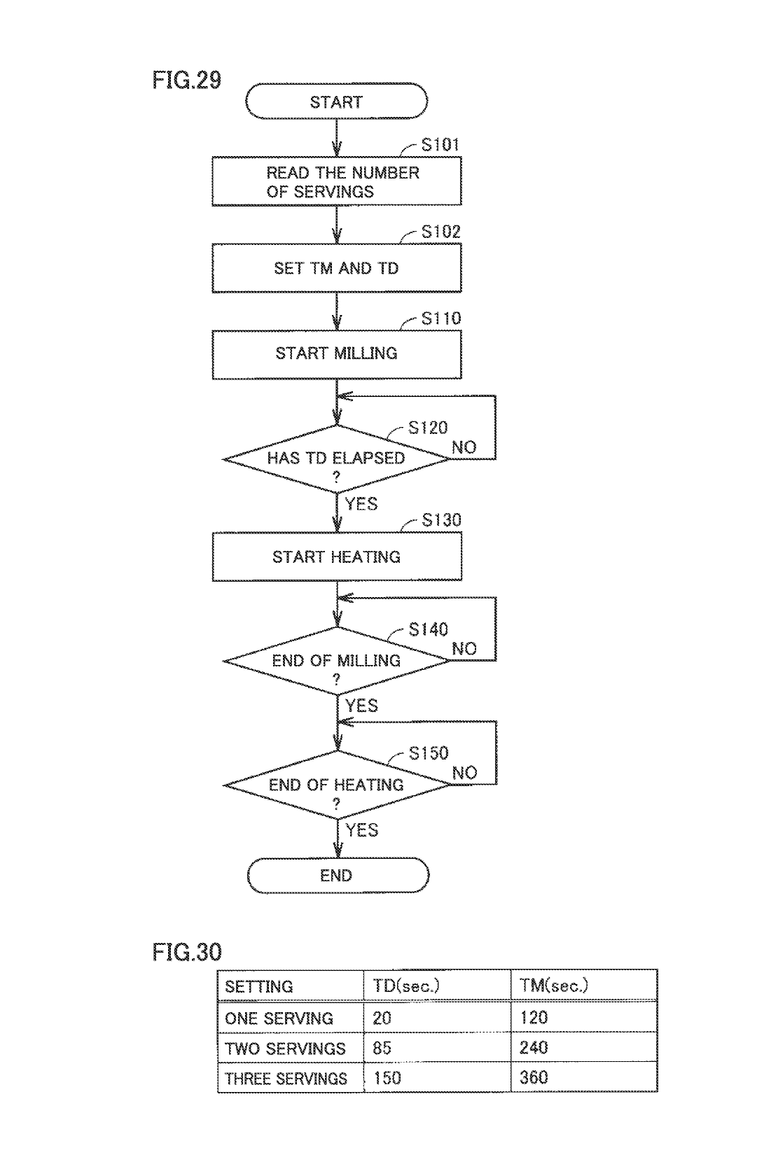

FIG. 29 is a flowchart of processing performed in beverage preparation apparatus 1 in the second embodiment. A flow of processing for preparation of a beverage by beverage preparation apparatus 1 in the second embodiment will be described with reference to FIG. 29. Processing in FIG. 29 is started, for example, in response to an operation of a start button which is a part of operation portion 911.

Referring to FIG. 29, in step S101, CPU 901 reads contents of setting as to how many servings should be prepared at a time.

Then, in step S102, CPU 901 specifies and sets a time period (hereinafter also referred to as a “time period TM”) for grating of tea leaves by milling unit 300 and time period TD based on the contents of setting read in step S101. Setting of time period TM and time period TD in step S102 is made, for example, by writing specified time periods into a storage area for those time periods in RAM 902, however, it may be replaced with any known technique. Then, control proceeds to step S110.

Time period TM and time period TD are specified in step S102, for example, by making use of information stored in memory 903. FIG. 30 is a diagram schematically showing one example of information stored in memory 903 of beverage preparation apparatus 1 in the second embodiment.

In FIG. 30, time period TD and time period TM are associated with a set number of persons (the number of persons to whom beverages are to be served). For example, when the number of persons to whom a beverage is to be served is “1”, time period TD is set to 20 seconds and time period TM is set to 120 seconds. The information shown in FIG. 30 may be stored in a storage device outside beverage preparation apparatus 1 and CPU 901 may read the information from the storage device. A numeric value shown in FIG. 30 is merely by way of example, and does not limit the present disclosure.

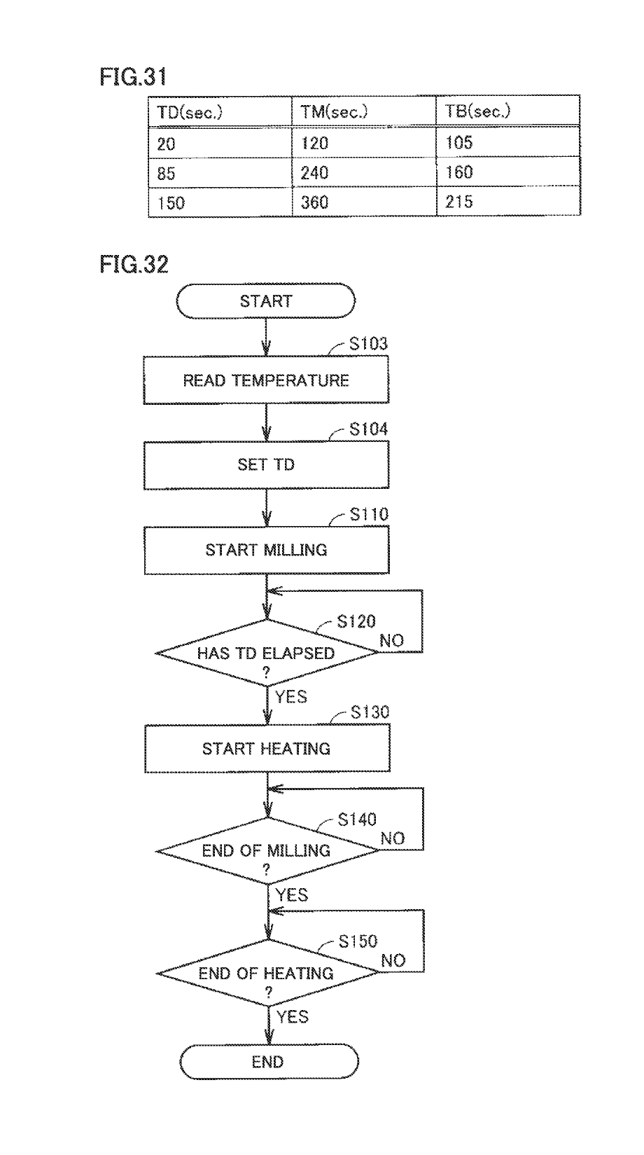

Relation between time period TD and time period TM is determined, for example, by making use of a time period (hereinafter also referred to as a time period “TB” as appropriate) required for heating of water in hot water supply pipe 150 by heater 160 corresponding to each setting. FIG. 31 is a diagram schematically showing one example of relation among time period TB, time period TM, and time period TD in the second embodiment. Time period TB represents an average value of time periods required for heating water in an amount necessary for preparing a beverage for a set number of persons at a room temperature to a “prescribed temperature” described above.

Time period TD is derived by subtracting time period TM from a result of addition of a time period of a prescribed length (for example, a time period expected to be required for a user to introduce tea leaf powders obtained by milling unit 300 into agitation unit 500 (5 seconds, by way of example)) to time period TM. For example, when the number of persons for whom a beverage is prepared is “1”, time period TD is set to a time period (20 seconds) derived by subtracting time period TB (105 seconds) from a time period (125 seconds) derived by adding a time period of a prescribed length (5 seconds) to time period TM (120 seconds). According to the above, in beverage preparation apparatus 1 in the second embodiment, even when time period TB is stored in memory 903 instead of time period TD shown in FIG. 30, CPU 901 can derive time period TD.

Referring back to FIG. 29, after time period TM and time period TD are set in step S102, CPU 901 performs control in step S120 to step S150. Contents of control in step S120 to step S150 are the same as the contents of control in the corresponding steps in the first embodiment described with reference to FIG. 27. In the second embodiment, grating of tea leaves started in step S110 ends after lapse of time period TM since start.

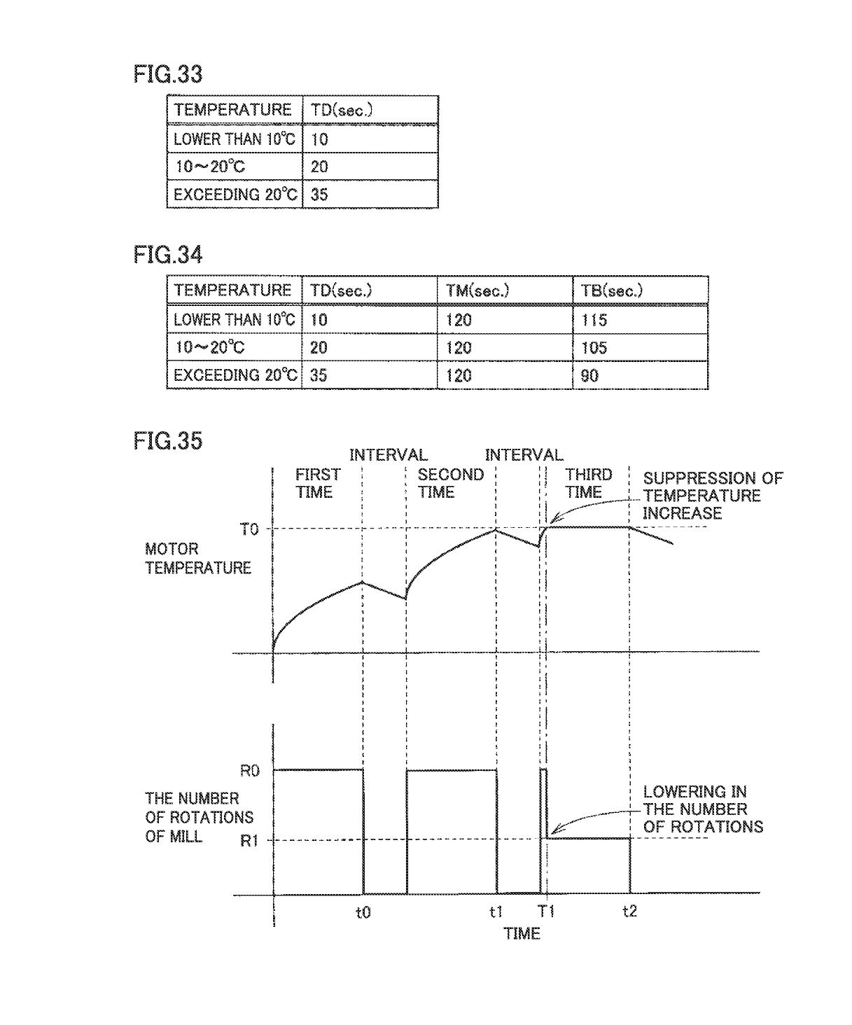

In the second embodiment, as an amount of a beverage prepared by beverage preparation apparatus 1 (the number of persons to whom a prepared beverage is served) is varied, a time period required for grating of tea leaves and a time period required for heating of water are varied. In the second embodiment, as the amount of a beverage is greater (the number of persons to be served is greater), time period TD is longer as shown in FIG. 33.

### Third Embodiment

A hardware configuration of beverage preparation apparatus 1 in a third embodiment can be the same as in the first embodiment. In beverage preparation apparatus 1 in the third embodiment, time period TD may be set in accordance with a temperature of water in hot water supply pipe 150 before heating by heater 160.

FIG. 32 is a flowchart of processing performed in beverage preparation apparatus 1 in the third embodiment. A flow of processing for preparation of a beverage by beverage preparation apparatus 1 in the third embodiment will be described with reference to FIG. 32. The processing in FIG. 32 is started, for example, in response to an operation of a start button which is a part of operation portion 911.

Referring to FIG. 32, in step S103, CPU 901 reads a result of measurement (a temperature) with thermometer 914.

Then, in step S104, CPU 901 specifies and sets time period TD based on the temperature read in step S103. Setting of time period TD in step S104 is made, for example, by writing a specified time period into a storage area for time period TD in RAM 902, however, it may be replaced with any known technique. Then, control proceeds to step S110.

Time period TD is specified in step S104, for example, by making use of information stored in memory 903. FIG. 33 is a diagram schematically showing one example of information stored in memory 903 of beverage preparation apparatus 1 in the third embodiment.

in FIG. 33, time period TD is associated with a temperature measured with thermometer 914. For example, when a measured temperature is lower than 10° C., time period TD is set to 10 seconds. When a measured temperature is not lower than 10° C. and not higher than 20° C., time period TD is set to 20 seconds. When a measured temperature exceeds 20° C., time period TD is set to 35 seconds. A numeric value shown in FIG. 30 is merely by way of example, and does not limit the present disclosure.

Relation between a measured temperature and time period TD is determined, for example, by making use of time period TB corresponding to a measured temperature. FIG. 34 is a diagram schematically showing one example of relation among a measured temperature, time period TB, time period TM, and time period TD in the third embodiment.

As shown in FIG. 34, time period TM is constant even when a measured temperature varies, whereas time period TB is shorter as a measured temperature is higher. Therefore, in order to bring the timing of end of heating of water in hot water supply pipe 150 closer to the timing of end of grating of tea leaves by milling unit 300, a time period from start of grating of tea leaves by milling unit 300 until start of heating of water in hot water supply pipe 150 should be longer as time period TB is shorter. Therefore, in the example shown in FIGS. 33 and 34, time period TD is set to be longer as time period TB is shorter.

Referring back to FIG. 32, after time period TD is set in step S104, CPU 901 performs control in step S120 to step S150. Contents of control in step S120 to step S150 are the same as the contents of control in the corresponding steps in the first embodiment described with reference to FIG. 27.

### Fourth Embodiment

A hardware configuration of beverage preparation apparatus 1 in a fourth embodiment can be the same as in the first embodiment. In beverage preparation apparatus 1 in the fourth embodiment, CPU 901 controls the number of rotations of motor for milling 121 based on a result of measurement with thermistor 122 during grating of tea leaves by milling motor unit 120.

FIG. 35 is a diagram schematically showing relation between a temperature measured with thermistor 122 and the number of rotations of relative rotation in mill 2 in the fourth embodiment. In FIG. 35, a temperature measured with thermistor 122 is shown as a “motor temperature.” In FIG. 35, one grating operation is shown as a grating pattern including two intervals. One grating operation refers, for example, to an operation for grating tea leaves by milling motor unit 120 performed in response to an operation of the start button once in beverage preparation apparatus 1.

In the grating operation shown in FIG. 35, a temperature measured with thermistor 122 increases with continued rotation of motor for milling 121. During the interval between rotations, a temperature measured with thermistor 122 slightly lowers. When rotation is resumed, however, a temperature measured with thermistor 122 again increases.

In the fourth embodiment, when a temperature measured with thermistor 122 reaches a predetermined temperature (a “temperature T0” in FIG. 35) (“time T1” in FIG. 35), CPU 901 lowers the number of rotations of motor for milling 121. Thus, increase in temperature of motor for milling 121 to a temperature at which motor for milling 121 should be stopped can be avoided. By avoiding a high temperature of motor for milling 121, loss of flavor of tea leaves set in beverage preparation apparatus 1 can also be avoided. By lowering the number of rotations of relative rotation in mill 2 as well, loss of flavor of tea leaves set in beverage preparation apparatus 1 can be avoided.

In the fourth embodiment, the number of rotations of motor for milling 121 is controlled based on the number of relative rotations between upper mill 360 and lower mill 350 of mill 2 instead of a temperature measured with thermistor 122. More specifically, CPU 901 counts an accumulated time period during which motor for milling 121 has rotated at the number of rotations equal to or higher than a prescribed number of rotations in one grating operation. When the accumulated time period exceeds a predetermined certain time period, CPU 901 lowers the number of rotations of motor for milling 121 to a predetermined specific number of rotations.

### Fifth Embodiment

A hardware configuration of beverage preparation apparatus 1 in a fifth embodiment can be the same as in the first embodiment. In beverage preparation apparatus 1 in the fifth embodiment, during grating of tea leaves by milling motor unit 120, CPU 901 has a grating operation by milling motor unit 120 end even before lapse of time period TM if a state that a rotation signal from motor for milling 121 exceeds a certain value has continued for a certain period of time. Thus, when grating is completed before lapse of time period TM since start of grating, unnecessarily continued drive of motor for milling 121 can be avoided.

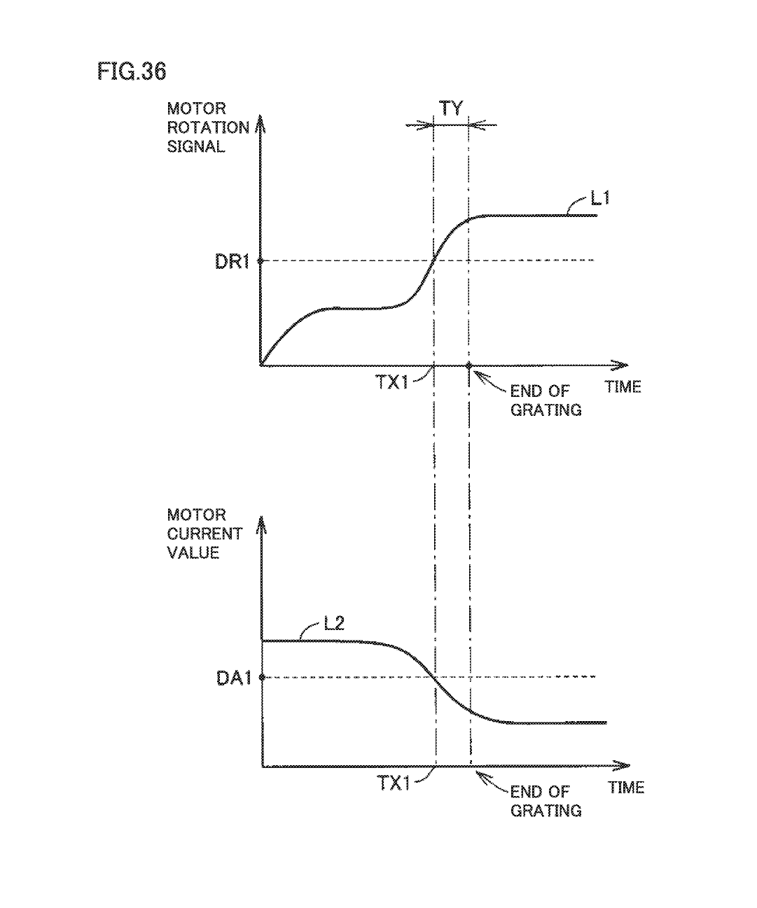

FIG. 36 is a diagram showing one example of variation in motor rotation signal with lapse of time in a grating operation and one example of variation in motor current value with lapse of time in the grating operation in beverage preparation apparatus 1 in the fifth embodiment. The motor rotation signal is measured with rotation sensor 913.

A motor current value is measured with ammeter 912.

In FIG. 36, variation in motor rotation signal is shown with a line L1. The motor rotation signal becomes higher from start of a grating operation (time TX0), becomes substantially constant, thereafter abruptly becomes higher at time TX1, and thereafter again becomes substantially constant. The motor rotation signal exceeds DR1 representing one example of a “certain value” at time TX1. Then, CPU 901 has a grating operation by milling motor unit 120 end at the time point of lapse of a time period TY since time TX1.

CPU 901 may determine the timing to quit the grating operation by milling motor unit 120 by making use of a motor current value instead of a motor rotation signal. When a motor current value is made use of, CPU 901 has a grating operation by milling motor unit 120 end on condition that a state that a motor current value is lower than a certain value has continued for a certain period of time.

Specifically, in FIG. 36, variation in motor current value is shown with a line L2. A motor current value is substantially constant from start of a grating operation (time TX0), abruptly lowers at time TX1, and thereafter again becomes substantially constant. A motor current value is lower than DA1 representing one example of a “certain value” at time TX1. Then, CPU 901 has a grating operation by milling motor unit 120 end at the time point of lapse of time period TY since time TX1.

### Sixth Embodiment

A hardware configuration of beverage preparation apparatus 1 in a sixth embodiment can be the same as in the first embodiment. In beverage preparation apparatus 1 in the sixth embodiment, a degree of milling of tea leaves may be set. Milling motor unit 120 performs a grating operation in an operation pattern in accordance with a degree of milling of tea leaves.

At least one of one or more operation patterns shown in the sixth embodiment includes an operation for forward rotation of mill 2 and an operation for reverse rotation of mill 2. Forward rotation means an operation of mill 2 in which upper mill 360 and lower mill 350 rotate relatively to each other in a direction in which powders grated in mill 2 are fed from the central portion to the outer circumferential portion of mill 2 through feed groove 202 (see FIG. 13). Reverse rotation means an operation of mill 2 in which directions of relative rotation of upper mill 360 and lower mill 350 are reverse to the forward rotation. In reverse rotation, movement of the powders grated in mill 2 from the central portion to the outer circumferential portion of mill 2 is suppressed as compared with movement in forward rotation.

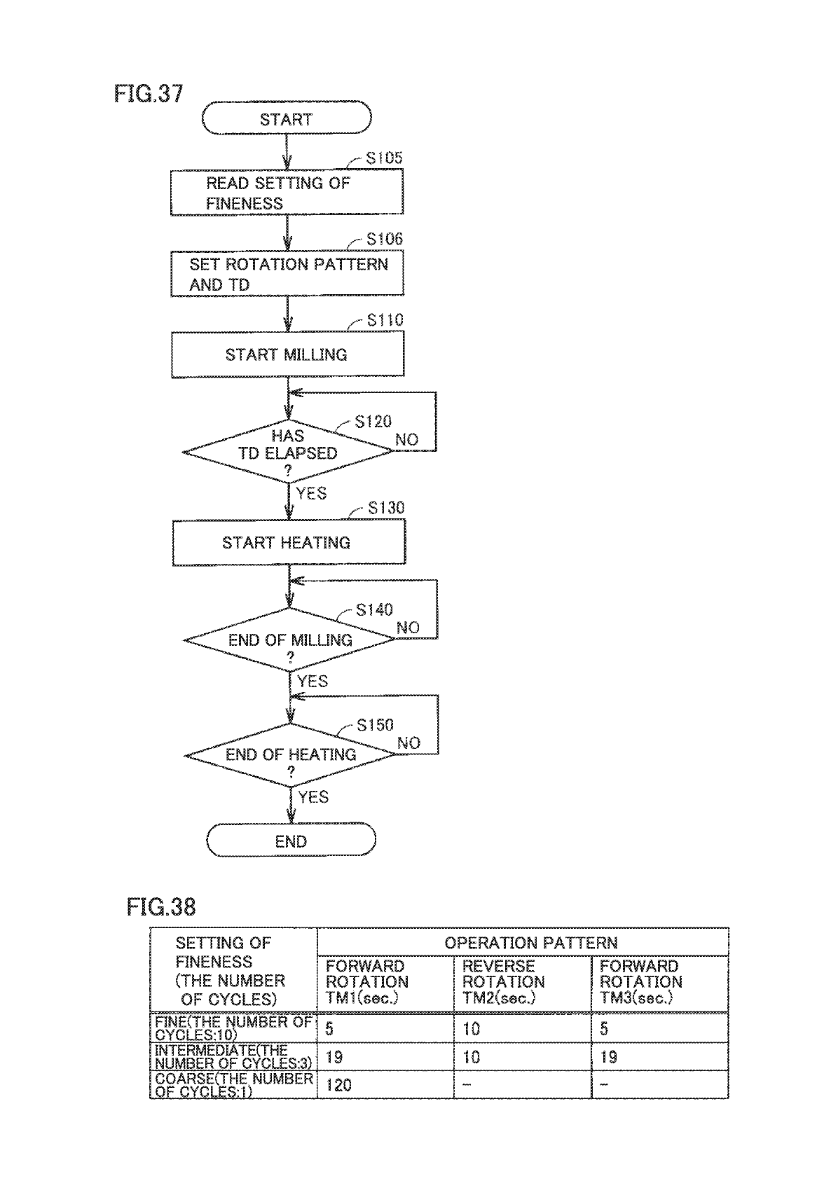

FIG. 37 is a flowchart of processing performed in beverage preparation apparatus 1 in the sixth embodiment. A flow of processing for preparation of a beverage by beverage preparation apparatus 1 in the sixth embodiment will be described with reference to FIG. 37. Processing in FIG. 37 is started, for example, in response to an operation of a start button which is a part of operation portion 911.

Referring to FIG. 37, in step S105, CPU 901 reads contents of setting as to a degree (fineness) of milling of tea leaves. Contents of setting are input to beverage preparation apparatus 1, for example, by an operation onto operation portion 911.

Then, in step S106, CPU 901 specifies and sets a grating operation pattern based on fineness read in step S105. Setting of the operation pattern in step S106 is made, for example, by writing a specified operation pattern into a storage area for the operation pattern in RAM 902, however, it may be replaced with any known technique. Then, control proceeds to step S110.

An operation pattern will be described here. FIG. 38 is a diagram schematically showing one example of information stored in memory 903 of beverage preparation apparatus 1 in the sixth embodiment.

In FIG. 38, contents of operation patterns are associated with set fineness (three levels of “fine”, “intermediate”, and “coarse”). For example, an operation pattern in the case of setting “fine” is ten repetitions of a cycle in which mill 2 is operated for 5 seconds in forward rotation, operated for 10 seconds in reverse rotation, and thereafter operated for 5 seconds in forward rotation. An operation pattern in the case of setting “intermediate” is three repetitions of a cycle in which mill 2 is operated for 19 seconds in forward rotation, operated for 10 seconds in reverse rotation, and thereafter operated for 19 seconds in forward rotation. An operation pattern in a case of setting “coarse” is an operation of mill 2 in forward rotation for 120 seconds.

Referring back to FIG. 37, after an operation pattern is set in step S106, CPU 901 performs control in step S120 to step S150. Contents of control in step S120 to step S150 are the same as the contents of control in the corresponding steps in the first embodiment described with reference to FIG. 27.

In milling (the grating operation) in the sixth embodiment, motor for milling 121 drives such that mill 2 operates in accordance with the operation pattern set in step S106. In the sixth embodiment, when tea leaves are finely milled, not only a time period for grating is simply increased, but also directions of rotation of upper mill 360 and lower mill 350 in mill 2 are relatively varied. In particular when a mill is small, a time period for grating is relatively short, and therefore, such a situation that powders grated by mill 2 are fed to the outside of mill 2 along feed groove 202 before the grating operation is completed is expected. Namely, such a situation that powders grated by mill 2 are fed to the outside of mill 2 before they are grated to desired fineness is expected. In the sixth embodiment, since an operation of mill 2 includes alternate forward rotation and reverse rotation, such a situation that powders grated by mill 2 are fed to the outside of mill 2 before they are grated to desired fineness can be avoided.

Depending on contents of setting as to a degree of milling of tea leaves, a time period (time period TM) required for a grating operation by milling motor unit 120 may be varied. For example, in an example shown in FIG. 38, when setting “fine” is made, time period TM is set to 150 seconds, whereas when setting “intermediate” or “coarse” is made, time period TM is set to 120 seconds. When time period TM is thus shorter, time period TD is preferably accordingly varied to be shorter.

It should be understood that the embodiments and modifications thereof disclosed herein are illustrative and non-restrictive in every respect. The scope of the present disclosure is defined by the terms of the claims, rather than the description above, and is intended to include any modifications within the scope and meaning equivalent to the terms of the claims.

### REFERENCE SIGNS LIST

1 beverage preparation apparatus; 100 apparatus main body; 110 control unit; 111 control device; 120 milling motor unit; 130 milling coupling mechanism; 140 agitation motor unit; 150 hot water supply pipe; 160 heater; 170 hot water supply nozzle; 180 milling unit attachment region; 190 agitation unit attachment region; 300 milling unit; 310 milling case; 312a outlet port; 310w window for coupling; 320 hopper portion; 330 cover for object to be grated; 340 powder scraper; 345 milling shaft; 350 lower mill; 355 core; 360 upper mill; 370 upper mill holding member; 390 spring holding member; 500 agitation unit; 510 agitation tank; 520 grip; 530 agitation cover; 531 powder inlet; 532 hot water supply inlet; 540 discharge port opening and closing mechanism; 541 discharge port; 542 operation lever; 543 opening and closing nozzle; 544 tank bottom hole; 550 agitation blade; 551 bearing portion; 560 rotation shaft; 700 water tank; 710 tank main body; 720 tank cover; 800 tea leaf powder tray; 900 placement base; 901 CPU; 902 RAM; 903 memory; 904 timer; 911 operation portion; 912 ammeter; 913 rotation sensor; 914 thermometer; and 921 display portion.

1. A beverage preparation apparatus for serving a beverage by mixing powders of food and a liquid, comprising:
a grating mechanism for producing powders of food by grating the food;
a heating mechanism for heating a liquid for preparing a beverage by mixing with the powders produced by the grating mechanism; and
a control portion for controlling operations of the grating mechanism and the heating mechanism,
the control portion starting heating of the liquid by the heating mechanism after a given time has elapsed since start of grating of the food by the grating mechanism.

2. The beverage preparation apparatus according to claim 1, wherein the given time is longer as an amount of the beverage served by the beverage preparation apparatus is greater.

3. The beverage preparation apparatus according to claim 1, wherein
the given time is longer as a temperature at beginning of heating of the liquid heated by the heating mechanism is higher.

4. The beverage preparation apparatus according to claim 1, wherein
the grating mechanism includes a moving element for grating the food and a motor for driving the moving element,
the beverage preparation apparatus further comprises measurement means for measuring a temperature of the motor, and
the control portion lowers driving force of the motor when a temperature measured with the measurement means exceeds a prescribed temperature.

5. The beverage preparation apparatus according to claim 1, wherein
the grating mechanism includes a moving element for grating the food and a motor for driving the moving element,
the beverage preparation apparatus further comprises measurement means for measuring a rotation signal of the motor, and
the control portion has grating of the food by the grating mechanism end when the rotation signal of the motor exceeds a certain value in grating of the food by the grating mechanism.

6. The beverage preparation apparatus according to claim 2, wherein
the given time is longer as a temperature at beginning of heating of the liquid heated by the heating mechanism is higher.

7. The beverage preparation apparatus according to claim 2, wherein
the grating mechanism includes a moving element for grating the food and a motor for driving the moving element,
the beverage preparation apparatus further comprises measurement means for measuring a temperature of the motor, and
the control portion lowers driving force of the motor when a temperature measured with the measurement means exceeds a prescribed temperature.

8. The beverage preparation apparatus according to claim 3, wherein
the grating mechanism includes a moving element for grating the food and a motor for driving the moving element,
the beverage preparation apparatus further comprises measurement means for measuring a temperature of the motor, and
the control portion lowers driving force of the motor when a temperature measured with the measurement means exceeds a prescribed temperature.

9. The beverage preparation apparatus according to claim 2, wherein
the grating mechanism includes a moving element for grating the food and a motor for driving the moving element,
the beverage preparation apparatus further comprises measurement means for measuring a rotation signal of the motor, and
the control portion has grating of the food by the grating mechanism end when the rotation signal of the motor exceeds a certain value in grating of the food by the grating mechanism.

10. The beverage preparation apparatus according to claim 3, wherein
the grating mechanism includes a moving element for grating the food and a motor for driving the moving element,
the beverage preparation apparatus further comprises measurement means for measuring a rotation signal of the motor, and
the control portion has grating of the food by the grating mechanism end when the rotation signal of the motor exceeds a certain value in grating of the food by the grating mechanism.
